(19) United States
(12) Patent Application Publication
(10) Pub. No.: US 2025/0218193 A1
(43) Pub. Date: Jul. 3, 2025

(54) SYSTEMS AND METHODS FOR REFUSE COLLECTION VERIFICATION

(71) Applicant: Oshkosh Corporation, Oshkosh, WI (US)

(72) Inventors: Leo Van Kampen, Conestogo (CA); Vince Schad, Oshkosh, WI (US); Steve Wagester, Oshkosh, WI (US); Brian Thomas, Oshkosh, WI (US)

(73) Assignee: Oshkosh Corporation, Oshkosh, WI (US)

(21) Appl. No.: 19/003,651

(22) Filed: Dec. 27, 2024

Related U.S. Application Data
(60) Provisional application No. 63/615,649, filed on Dec. 28, 2023.
(60) Provisional application No. 63/615,527, filed on Dec. 28, 2023.

(51) Int. Cl. G06V 20/58; B60W 50/14

(52) U.S. Cl. CPC G06V 20/58; B60W 50/14

(57) ABSTRACT

A system for verifying refuse collection includes a camera system coupled to a refuse vehicle and configured to detect an object on one or more sides of the refuse vehicle and one or more memory devices storing instructions thereon that, when executed by one or more processors, cause the one or more processors to receive image data from the camera system; transmit the image data to an object detection system; determine whether the object is present at a location, whether the object is expected to be present for collection at the location, and whether the object is collected; and instruct the camera system to store an image of the location on the one or more memory devices.

### CROSS-REFERENCE TO RELATED APPLICATIONS

This application claims the benefit of and priority to U.S. Provisional Application No. 63/615,527, filed Dec. 28, 2023, and U.S. Provisional Application No. 63/615,649, filed Dec. 28, 2024, the entire contents of which are hereby incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a system for verifying refuse collection. The system includes a camera system coupled to a refuse vehicle and configured to detect an object proximate to the refuse vehicle. The system also includes one or more memory devices storing instructions thereon that, when executed by one or more processors, cause the one or more processors to: receive image data from the camera system; transmit the image data to an object detection system; and determine based on stored data, whether the object is expected to be present for collection at a location. Based on the determining that the object is expected to be present for collection at the location, the one or more processors instruct the camera system to store an image of the location on the one or more memory devices.

Another embodiment of the present disclosure relates to a method for verifying refuse collection. The method includes receiving image data from a camera system coupled to a refuse vehicle; processing the image data by inputting the image data into an object detection system; and determining one or more of: based on an output of the object detection system, whether an object is present at a location; and based on stored data, whether the object is expected to be present for collection at the location. Based on determining whether the object is expected to be present for collection at the location, the method includes instructing the camera system to store an image of the location on a memory.

Another embodiment of the present disclosure relates to a refuse vehicle. The refuse vehicle includes a camera system configured to detect an object proximate to the refuse vehicle and one or more memory devices storing instructions thereon. When executed by one or more processors, the instructions cause the one or more processors to receive image data from the camera system and transmit the image data to an object detection system. The instructions also cause the one or more processors to determine, based on stored data, whether the object is expected to be present for collection at a location, and based on determining that the object is expected to be present for collection at the location, instruct the camera system to store an image of the location on the one or more memory devices.

Another embodiment of the present disclosure relates to a system for tracking refuse collection vehicles. The system includes one or more memory devices having instructions stored thereon that, when executed by one or more processors, cause the one or more processors to perform operations. The operations include receiving, from a user device, a first user input indicating one or more parameters of a geofence, the geofence defining a virtual perimeter around a geographical location; receiving a refuse collection route associated with a refuse collection vehicle; receiving, from the user device, a reminder time threshold; determining an arrival time of the refuse vehicle to the geographical location based on a current location of the refuse vehicle and the refuse collection route; determining whether the arrival time exceeds the reminder time threshold; and when the arrival time falls below the reminder time threshold, transmitting, to the user device, a first notification indicating that the refuse collection vehicle is approaching the geographic location.

In some embodiments, the first notification is transmitted to the user device by at least one of a text message, a push notification, an automated phone call, or an email.

In some embodiments, the operations further include transmitting, to an access control system and in response to the arrival time meeting or falling below the reminder time threshold, a command that causes an actuator to facilitate access to a refuse can containment area.

In some embodiments, the first notification further indicates a time of arrival of the refuse collection vehicle to a central point of the geofence.

In some embodiments, the operations also include determining whether the refuse collection vehicle previously collected refuse at the geographical location, and upon determining that the refuse collection vehicle previously collected refuse at the geographical location, preventing a second notification from transmitting to the user device.

In some embodiments, the one or more parameters of the geofence include a central location for the geofence and a radius of the geofence.

In some embodiments, the operations also include presenting, via a user interface, a map of an area based on a second user input of an address, and receiving, via the user interface, a third user input defining one or more boundaries of the geofence within the map.

In some embodiments, the refuse collection vehicle includes a global positioning system (GPS) transceiver. In such implementations, the current location of the refuse collection vehicle may be determined based on GPS data received by a server from the refuse collection vehicle.

In some embodiments, the refuse collection vehicle includes a cellular network transceiver and the current location of the refuse collection vehicle is triangulated based on signals from one or more cellular towers.

Another embodiment of the present disclosure relates to a method for tracking a refuse collection vehicle. The method comprises receiving, by a server, a first user input indicating one or more parameters of a geofence, the geofence defining a virtual perimeter around a geographical location; receiving, by the server, a refuse collection route associated with the refuse collection vehicle; receiving, by the server, a reminder time threshold; determining, by the server, an arrival time of the refuse collection vehicle to the geographical location based on a current location of the refuse collection vehicle and the refuse collection route; determining, by the server, whether the arrival time exceeds the reminder time threshold; and when the arrival time meets or falls below the reminder time threshold, causing, by the server, a first notification to be sent to a user device indicating that the refuse collection vehicle is approaching the geographical location.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a top view of a refuse vehicle, according to an exemplary embodiment;

FIG. 2 is a side view of a refuse vehicle, according to an exemplary embodiment;

FIG. 3 is a perspective view of a refuse vehicle, according to an exemplary embodiment;

FIG. 4 is a diagram illustrating a collection route for any of the refuse vehicles of FIGS. 1-3, according to an exemplary embodiment;

FIG. 5 is a diagram of a refuse can detection system for any of the refuse vehicles of FIGS. 1-3, according to an exemplary embodiment;

FIG. 6 is a diagram of an image captured by the refuse can detection system of FIG. 5, according to an exemplary embodiment;

FIG. 7 is a diagram of an image captured by the refuse can detection system of FIG. 5, according to an exemplary embodiment;

FIG. 8 is a block diagram of a tracking and alert system for residential refuse can collection, according to an exemplary embodiment;

FIG. 9 is an example diagram of a geofence, according to an exemplary embodiment;

FIG. 10 is a process for tracking a refuse vehicle and alerting a customer of an impending refuse can collection operation, according to an exemplary embodiment;

FIG. 11 is an example diagram of the geofence of FIG. 9, showing a refuse vehicle having a route that does not include a specific customer's location, according to an exemplary embodiment; and

FIG. 12 is an example diagram of the geofence of FIG. 9, showing a refuse vehicle having a route that does include a specific customer's location, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, systems and methods for verifying refuse collection are shown, according to various embodiments. A refuse can detection system may include a controller configured to receive and process data from one or more sensors or image capturing devices coupled to a refuse vehicle. The refuse vehicle travels along a route stopping at pickup locations to collect refuse stored in refuse cans and placed in a pickup location by a customer to be collected by the refuse vehicle. The system may process image, video, and sensor data gathered by the one or more sensors of image capturing devices to detect whether the refuse can is present or absent at any particular pickup location along the route, an owner of the refuse can(s), and/or to determine a type of refuse material stored within the refuse can(s).

The system may determine, from data transmitted to the refuse vehicle and/or stored onboard the refuse vehicle, whether a refuse can should be present at a customer location. In the event that a refuse can(s) is not detected by the system (e.g., at a location associated with a customer record, etc.), the system may be configured to record location data, by way of Global Positioning System (GPS) coordinates or by way of capturing environmental location data from the image capturing devices (e.g., address number, street signs, road markings, etc.) that records a location of where (e.g., which address, which customer, etc.) the system detected a missing refuse can (e.g., by way of a determination from the system that no refuse can is present). The system is configured to transmit data associated with the location of where the missing refuse can was detected to surrounding refuse vehicles within the area, a user device, a service manager (e.g., a fleet manager, etc.), or a network to be shared. In some embodiments, the system is configured to notify the operator of a missed refuse can, such as if the refuse vehicle passes a location at which a refuse can should be present and no refuse can is detected. In some embodiments, the system is configured to capture an image of the area at which the refuse can(s) should have been located, to determine whether a can is present from the image, and, responsive to a determination that the can(s) is missing, transmit and/or store the image.

In some embodiments, responsive to a determination that a can should be present for pickup at the customer location, the system commands a Human Machine Interface (HMI) of a vehicle to notify the driver of the location at which pickup has been scheduled or at which a refuse can(s) should be present (e.g., within a pickup time range for pickup, etc.). The notification may instruct the driver to drive along a route past the location to detect whether the refuse can has been placed at the pickup location.

The system may also record location data, by way of GPS coordinates or by way of capturing environmental location data from the image capturing devices (e.g., address number, street signs, road markings, etc.) that records a location of where (e.g., which address, which customer, etc.) the system detected a present refuse can (e.g., by way of a determination from the system that the refuse can is present) which should not be present (e.g., the present refuse can should have been collected and was not collected, the present refuse can is not associated with a customer, etc.). The system is configured to transmit data associated with the location of where the present refuse can was detected to surrounding refuse vehicles within the area, a user device, a service manager, or a network to be shared. The data may include a command commanding an HMI of a vehicle within the surrounding area to notify the driver of the location identified to have the present refuse can. The notification may instruct the driver to drive along a route past the location to detect whether the present refuse can has been placed at the pickup location, whether the present refuse can should have been placed at the pickup location, and/or whether the present refuse can was not collected.

### Refuse Vehicle

### Front-Loading Configuration

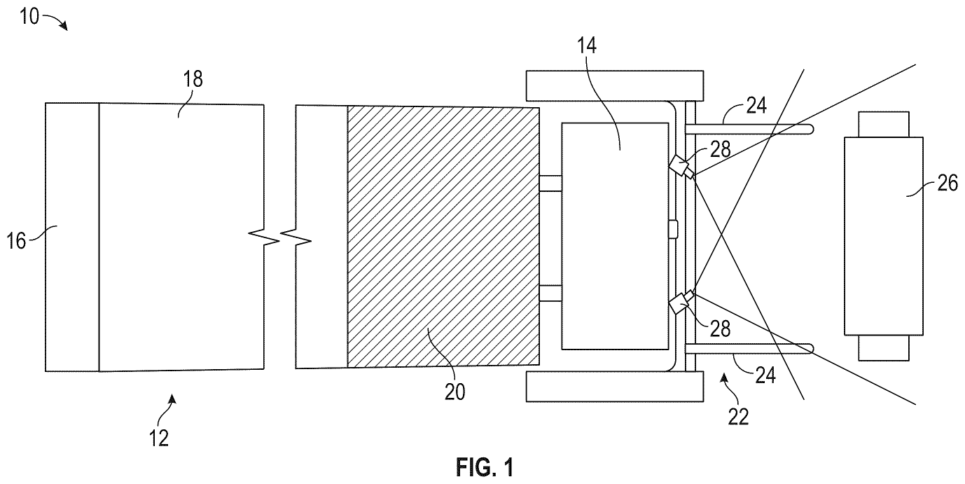

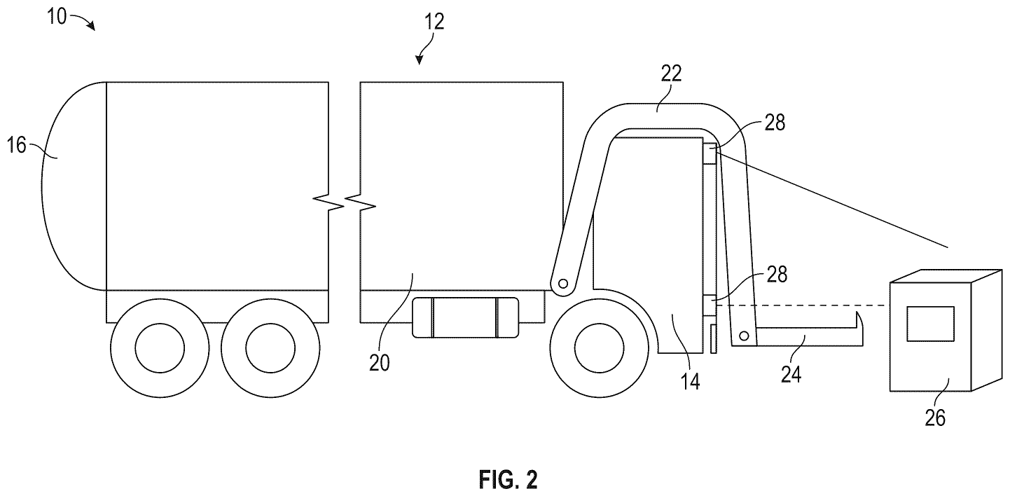

Referring to FIGS. 1 and 2, a vehicle, shown as refuse vehicle 10 (e.g., a garbage truck, a waste collection truck, a sanitation truck, etc.), is shown that is configured to collect and store refuse along a collection route. In the embodiment of FIGS. 1 and 2, the refuse vehicle 10 is configured as a front-loading refuse vehicle. The refuse vehicle 10 includes a chassis (not shown); a body assembly, shown as body 12, coupled to the frame (e.g., at a rear end thereof, etc.); and a cab, shown as cab 14, coupled to the frame (e.g., at a front end thereof, etc.). The cab 14 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). The refuse vehicle 10 includes a prime mover (not shown) coupled to the frame at a position beneath the cab 14. The engine is configured to provide power to tractive elements and/or to other systems of the refuse vehicle 10 (e.g., a pneumatic system, a hydraulic system, etc.). The engine may be configured to utilize one or more of a variety of fuels (e.g., gasoline, diesel, bio-diesel, ethanol, natural gas, etc.), according to various exemplary embodiments. The fuel may be stored in a tank (not shown) (e.g., a vessel, a container, a capsule, etc.) that is fluidly coupled with the engine through one or more fuel lines.

According to an alternative embodiment, the engine additionally or alternatively includes one or more electric motors (not shown) coupled to the frame (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine may transfer output torque to or drive the tractive elements (e.g., wheels, wheel assemblies, etc.) of the refuse vehicle 10 through a transmission (not shown). The engine, the transmission, and one or more shafts, axles, gearboxes, etc., may define a driveline of the refuse vehicle 10.

According to an exemplary embodiment, the refuse vehicle 10 is configured to transport the refuse from various waste receptacles within a municipality to a storage facility and/or processing facility (e.g., a landfill, an incineration facility, a recycling facility, etc.). The body 12 includes a plurality of panels (not shown), a tailgate 16, and a cover 18. The panels, the tailgate 16, and the cover 18 define a collection chamber (e.g., hopper, etc.), shown as refuse compartment 20. Loose refuse may be placed into the refuse compartment 20 where it may thereafter be compacted. The refuse compartment 20 may provide temporary storage for the refuse during transport to a waste disposal site and/or a recycling facility. In some embodiments, at least a portion of the body 12 and the refuse compartment 20 extend in front of the cab 14. According to the embodiment shown in FIGS. 1 and 2, the body 12 and the refuse compartment 20 are positioned behind the cab 14. In some embodiments, the refuse compartment 20 includes a hopper volume and a storage volume. The refuse may be initially loaded into the hopper volume and thereafter transferred and/or compacted into the storage volume. According to an exemplary embodiment, the hopper volume is positioned forward of the cab 14 (e.g., refuse is loaded into a position of the refuse compartment 20 in front of the cab 14, a front-loading refuse vehicle, etc.). In other embodiments, the hopper volume is positioned between the storage volume and the cab 14 (e.g., refuse is loaded into a position of the refuse compartment 20 behind the cab 14 and stored in a position further toward the rear of the refuse compartment 20). In yet other embodiments, the storage volume is positioned between the hopper volume and the cab 14 (e.g., a rear-loading refuse vehicle, etc.).

The tailgate 16 may be hingedly or pivotally coupled with the body 12 at a rear end of the body 12 (e.g., opposite the cab 14). The tailgate 16 may be driven to rotate between an open position and a closed position by tailgate actuators (not shown). The refuse compartment 20 may be hingedly or pivotally coupled with the frame such that the refuse compartment 20 can be driven to raise or lower while the tailgate 16 is open in order to dump contents of the refuse compartment 20 at a landfill. The refuse compartment 20 may include a packer assembly (e.g., a compaction apparatus) positioned therein that is configured to compact loose refuse.

Referring still to FIGS. 1 and 2, the refuse vehicle 10 includes a first lift mechanism or system (e.g., a front-loading lift assembly, etc.), shown as lift assembly 22. The lift assembly 22 includes a pair of arms, shown as lift arms 24, coupled to at least one of the frame or the body 12 on either side of the refuse vehicle 10 such that the lift arms 24 extend forward of the cab 14 (e.g., a front-loading refuse vehicle, etc.). The lift arms 24 may be rotatably coupled to the frame with a pivot (e.g., a lug, a shaft, etc.). The lift assembly 22 includes lift arm actuators (not shown) coupled to the frame and the lift arms 24. The lift arm actuators are positioned such that extension and retraction thereof rotates the lift arms 24 about an axis extending through the pivot, according to an exemplary embodiment. The lift arms 24 may be removably coupled to a container, shown as refuse container 26. The lift arms 24 are configured to be driven to pivot by the lift arm actuators to lift and empty the refuse container 26 into the hopper volume for compaction and storage. The lift arms 24 may be coupled with a pair of forks or elongated members that are configured to removably couple with the refuse container 26 so that the refuse container 26 can be lifted and emptied. The refuse container 26 may be similar to the container attachment 200 as described in greater detail in U.S. application Ser. No. 17/558,183, filed Dec. 12, 2021, the entire disclosure of which is incorporated by reference herein.

### Rear-Loading Configuration

The refuse vehicle 10 may be configured as a rear-loading refuse vehicle (not shown), according to some embodiments. In the rear-loading embodiment of the refuse vehicle 10, the tailgate 16 defines an opening through which loose refuse may be loaded into the refuse compartment 20. The tailgate 16 may also include a packer (e.g., a packing assembly, a compaction apparatus, a claw, a hinged member, etc.) that is configured to draw the refuse into the refuse compartment 20 for storage. Similar to the embodiment of the refuse vehicle 10 described in FIGS. 1 and 2 above, the tailgate 16 may be hingedly coupled with the refuse compartment 20 such that the tailgate 16 can be opened or closed during a dumping operation.

### Side-Loading Configuration

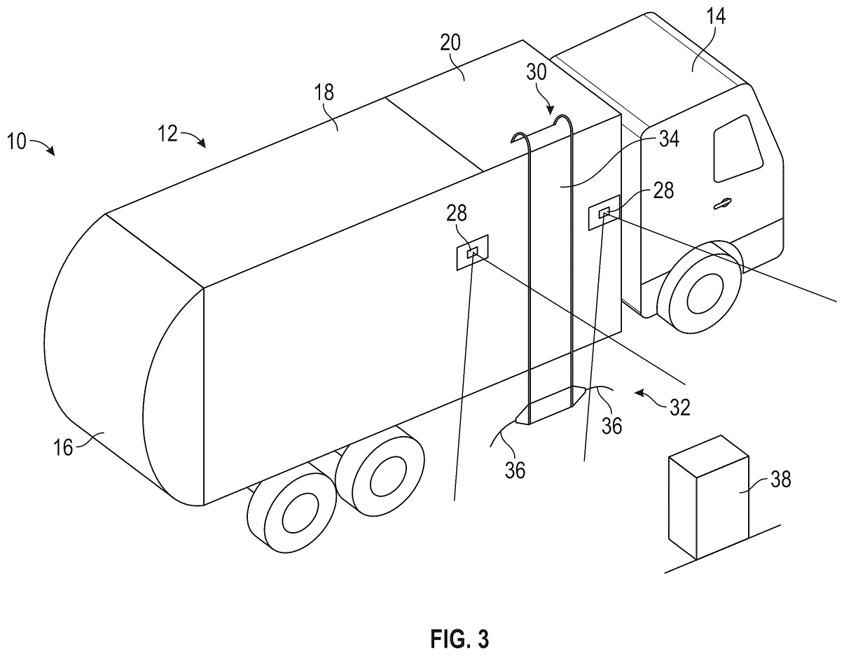

Referring now to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 30. The lift assembly 30 includes a grabber assembly, shown as grabber assembly 32, movably coupled to a track, shown as track 34, and configured to move along an entire length of the track 34. According to the exemplary embodiment shown in FIG. 3, track 34 extends along substantially an entire height of body 12 and is configured to cause the grabber assembly 32 to tilt near an upper height of body 12. In other embodiments, the track 34 extends along substantially an entire height of body 12 on a rear side of body 12. The refuse vehicle 10 can also include a reach system or assembly coupled with the body 12 or the frame of the refuse vehicle 10 and the lift assembly 30. The reach system can include telescoping members, a scissors stack, etc., or any other configuration that can extend or retract to provide additional reach of grabber assembly 32 for refuse collection.

Referring still to FIG. 3, grabber assembly 32 includes a pair of grabber arms shown as grabber arms 36. The grabber arms 36 are configured to rotate about an axis extending through a bushing. The grabber arms 36 are configured to releasably secure a refuse container 38 to grabber assembly 32, according to an exemplary embodiment. The grabber arms 36 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 36 are rotated towards each other such that the refuse container is grasped therebetween. In the disengaged state, the grabber arms 36 rotate outwards such that the refuse container 38 is not grasped therebetween. By transitioning between the engaged state and the disengaged state, the grabber assembly 32 releasably couples the refuse container 38 with grabber assembly 32. The refuse vehicle 10 may pull up along-side the refuse container 38, such that the refuse container 38 is positioned to be grasped by the grabber assembly 32 therebetween. The grabber assembly 32 may then transition into an engaged state to grasp the refuse container 38. After the refuse container 38 has been securely grasped, the grabber assembly 32 may be transported along track 34 with the refuse container 38. When the grabber assembly 32 reaches the end of track 34, the grabber assembly 32 may tilt and empty the contents of the refuse container 38 in refuse compartment 20. The tilting is facilitated by the path of the track 34. When the contents of the refuse container 38 have been emptied into the refuse compartment 20, the grabber assembly 32 may descend along the track 34, and return the refuse container 38 to the ground. Once the refuse container 38 has been placed on the ground, the grabber assembly 32 may transition into the disengaged state, releasing the refuse container 38.

### Control System

The refuse vehicle 10 may include a control system that is configured to facilitate autonomous or semi-autonomous operation of the refuse vehicle 10, or components thereof. The control system includes a controller that is positioned on the refuse vehicle 10, a remote computing system, a telematics unit, one or more input devices, and one or more controllable elements. The input devices can include multiple sensors 28, a vision system (e.g., an awareness system), and a Human Machine Interface (HMI). The input devices can also include a positioning system, such as a global positioning system (GPS) transceiver, a radio transceiver for a cellular network, inertial sensors, ultra-wideband sensors/receivers, etc. In one example, refuse vehicle 10 includes at least a GPS transceiver for determining a location of refuse vehicle 10 as it operates (e.g., traverses a refuse can collection route). In another example, the location of refuse vehicle 10 may be triangulated based on signals from or more cellular radio transceivers, or by any combination of data from one or more components of a positioning system.

The controllable elements can include a driveline of the refuse vehicle 10, a braking system of the refuse vehicle 10, a steering system of the refuse vehicle 10, a lift apparatus (e.g., the lift assembly 22, the lift assembly 30, etc.), a compaction system (e.g., a packer assembly, the packer, etc.), body actuators (e.g., the tailgate actuators, lift actuators, dumping actuators, etc.), and/or an alert system.

The controller includes processing circuitry including a processor and memory. Processing circuitry can be communicably connected with a communications interface of controller such that processing circuitry and the various components thereof can send and receive data via the communications interface. Processor can be implemented as a general purpose processor, an application specific integrated circuit (ASIC), one or more field programmable gate arrays (FPGAs), a group of processing components, or other suitable electronic processing components.

The memory (e.g., memory, memory unit, storage device, etc.) can include one or more devices (e.g., RAM, ROM, flash memory, hard disk storage, etc.) for storing data and/or computer code for completing or facilitating the various processes, layers and modules described in the present application. The memory can be or include volatile memory or non-volatile memory. The memory can include database components, object code components, script components, or any other type of information structure for supporting the various activities and information structures described in the present application. According to some embodiments, the memory is communicably connected to the processor via the processing circuitry and includes computer code for executing (e.g., by at least one of the processing circuitry or the processor) one or more processes described herein.

The controller is configured to receive inputs (e.g., measurements, detections, signals, sensor data, etc.) from the input devices, according to some embodiments. In particular, the controller may receive a GPS location from the GPS system (e.g., current latitude and longitude of the refuse vehicle 10). The controller may receive sensor data (e.g., engine temperature, fuel levels, transmission control unit feedback, engine control unit feedback, speed of the refuse vehicle 10, etc.) from the sensors 28. The controller may receive image data (e.g., real-time camera data) from the vision system of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 14 of the refuse vehicle 10, etc.). The controller may receive user inputs from the HMI (e.g., button presses, requests to perform a lifting or loading operation, driving operations, steering operations, braking operations, etc.).

The controller may be configured to provide control outputs (e.g., control decisions, control signals, etc.) to the driveline (e.g., the engine, the transmission, the engine control unit, the transmission control unit, etc.) to operate the driveline to transport the refuse vehicle 10. The controller may also be configured to provide control outputs to the braking system to activate and operate the braking system to decelerate the refuse vehicle 10 (e.g., by activating a friction brake system, a regenerative braking system, etc.). The controller may be configured to provide control outputs to the steering system to operate the steering system to rotate or turn at least two of the tractive elements to steer the refuse vehicle 10. The controller may also be configured to operate actuators or motors of the lift apparatus (e.g., lift arm actuators) to perform a lifting operation (e.g., to grasp, lift, empty, and return a refuse container). The controller may also be configured to operate the compaction system to compact or pack refuse that is within the refuse compartment 20. The controller may also be configured to operate the body actuators to implement a dumping operation of refuse from the refuse compartment 20 (e.g., driving the refuse compartment 20 to rotate to dump the refuse at a landfill). The controller may also be configured to operate the alert system (e.g., lights, speakers, display screens, etc.) to provide one or more aural or visual alerts to nearby individuals.

The controller may also be configured to receive feedback from any of the driveline, the braking system, the steering system, the lift apparatus, the compaction system, the body actuators, or the alert system. The controller may provide any of the feedback to the remote computing system via the telematics unit. The telematics unit may include any wireless transceiver, cellular dongle, communications radios, antennas, etc., to establish wireless communication with the remote computing system. The telematics unit may facilitate communications with telematics units of nearby refuse vehicles 10 to thereby establish a mesh network of the refuse vehicles 10.

The controller is configured to use any of the inputs from any of the GPS system, the sensors 28, the vision system, or the HMI to generate controls for the driveline, the braking system, the steering system, the lift apparatus, the compaction system, the body actuators, or the alert system. In some embodiments, the controller is configured to operate the driveline, the braking system, the steering system, the lift apparatus, the compaction system, the body actuators, and/or the alert system to autonomously transport the refuse vehicle 10 along a route (e.g., self-driving), perform pickups or refuse collection operations autonomously, and transport to a landfill to empty contents of the refuse compartment 20. The controller may receive one or more inputs from the remote computing system such as route data, indications of pickup locations along the route, route updates, customer information, pickup types, etc. The controller may use the inputs from the remote computing system to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system may perform any of the route planning techniques as described in greater detail in U.S. application Ser. No. 18/111,137, filed Feb. 17, 2023, the entire disclosure of which is incorporated by reference herein. The remote computing system may implement any route planning techniques based on data received by the controller. In some embodiments, the controller is configured to implement any of the cart alignment techniques as described in U.S. application Ser. No. 18/242,224, filed Sep. 5, 2023, the entire disclosure of which is incorporated by reference herein. The refuse vehicle 10 and the remote computing system may also operate or implement geofences as described in greater detail in U.S. application Ser. No. 17/232,855, filed Apr. 16, 2021, the entire disclosure of which is incorporated by reference herein.

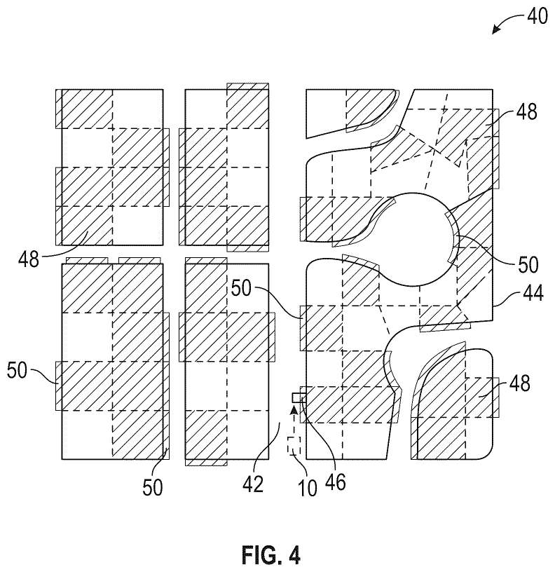

Referring now to FIG. 4, a diagram 40 illustrates a route 42 through a neighborhood 44 for the refuse vehicle 10. The route 42 includes future stops along the route 42 to be completed, present stops, and past stops that have already been completed. The route 42 may be defined and provided by the remote computing system. The remote computing system may also define or determine the future stops and the past stops along the route 42 and provide data regarding the geographic location of the future stops and the past stops to the controller of the refuse vehicle 10. The refuse vehicle 10 may use the route data and the stops data to autonomously transport along the route 42 and perform refuse collection at each stop. The route 42 may end at a landfill (e.g., an end location, a transfer station, etc.) where the refuse vehicle 10 may autonomously empty collected refuse, transport to a refueling location if necessary, and begin a new route.

The diagram 40 may be a map stored in vehicle memory to transmitted to the system via a network interface (e.g., from a fleet manager, etc.). In some embodiments, the map shows a real-time location of the refuse vehicle along the route based on GPS data. In some embodiments, the map also provides information regarding valid customers and areas along a route at which a can(s) is expected for associated customers. For example, the map may include shaded and/or color plots indicating valid customers. The map may also indicate locations at which a refuse container is expected for that customer such as by shading of curb locations along the route and/or other location identifiers. The refuse can detection system may use this data to determine whether images and/or video of different locations along the route should be captured and analyzed, as described in further detail below.

### Detecting Missing Refuse Cans

The refuse vehicle 10 includes an autonomous or partially autonomous refuse can detection system, according to an exemplary embodiment. The refuse can detection system is configured to capture data associated with a detection of a presence or an absence of objects such as refuse cans. The refuse can detection system is further configured to communicate with other refuse vehicles 10, user devices, a service manager, and/or a network to transmit the captured data. The refuse can detection system captures data from image and/or object systems (e.g., the sensors 28, the vision system, etc.) to detect and/or track whether the refuse cans 46 have been placed in a pickup location at stops (e.g., the future stops, the past stops, the present stops, etc.) along the route 42.

A refuse can 46 (e.g., the refuse container 26, the refuse container 38) is a container for collecting or storing garbage, recycling, compost, and other refuse, so that the garbage, recycling, compost, or other refuse can be pooled with other waste, and transported for further processing. Generally speaking, waste may be classified as residential, commercial, industrial, etc. As used here, a “refuse can” may apply to any of these categories, as well as others. Depending on the category and usage, a waste receptacle may take the form of a garbage can, a dumpster, a recycling “blue box,” a compost bin, etc. Further, refuse cans may be used for curb-side collection (e.g., at certain residential locations), as well as collection in other specified locations (e.g., in the case of dumpster collection).

A customer plot 48 is a location of a valid customer (e.g., a home of a customer, a business of a customer, a building, etc.). A pickup location 50 is a location where a customer (e.g., resident, homeowner, building manager, etc.) may place the refuse can 46 such that the system is capable of detecting (e.g., by way of the sensors 28 or the vision system) the presence and absence of the refuse can 46. By way of example, the pickup location 50 may be any curb-side location along the route 42, a location on a driveway, walkway, yard, etc. at the stop, a designated pickup location designated by the refuse collection company, a location called in by the customer, or any other location near or along the route 42. The pickup location 50 may indicate a location where a refuse can 46 is expected for the customer.

A customer may be verified as a valid customer. The refuse can 46 may possess an identifying feature such as a color, a logo, a barcode, a QR code, a Radio Frequency Identification (“RFID”) tag, etc. that is associated with the customer. The identifying feature of the refuse can 46 may verify that the refuse can 46 belongs to a certain verified customer. The identifying feature of the refuse can 46 may also help identify a correct waste stream or type of refuse contained within the refuse can 46.

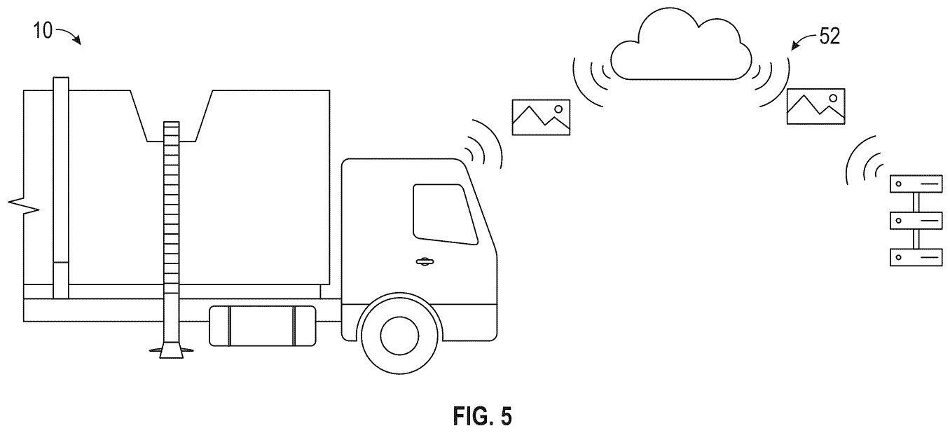

Referring to FIG. 5, the refuse can detection system includes one or more of the refuse vehicles 10, one or more user devices (e.g., smartphones, tablets, laptop computers, desktop computers, pagers, smart speakers, AI assistants, etc.), and a service manager (e.g., a cloud device, a cloud server, a cloud controller, etc.), shown as service manager 52.

The user devices facilitate communication between a customer and the refuse can detection system. By way of example, the customer may provide a command, such as a request for pickup of refuse to the refuse can detection system, through the user device. By way of another example, the refuse can detection system may communicate a current location of the refuse vehicle 10 to the customer through the user device. By way of another example, the refuse can detection system may transmit a notification to the user device to alert the customer that their refuse was not collected by the refuse vehicle 10 because the refuse can 46 was not detected at the pickup location 50 (e.g., a location where the customer would place the refuse can 46 to be picked up).

The service manager 52 may store data and manage the flow of information throughout the refuse can detection system. By way of example, the service manager 52 may track (e.g., retrieve and store) the current location of one or more refuse vehicles 10, the locations of each customer (e.g., the future stops, the past stops, etc.), indications that the refuse can 46 was not detected at a stop, requests by the customer to pick up refuse, or other information.

The service manager 52 may control operation of the refuse vehicle 10 and/or the user device. By way of example, in response to receiving a request for refuse collection from the user device of the customer, the service manager 52 may select a refuse vehicle 10 in the surrounding area (e.g., within 1 mile, within 5 miles, etc.) and provide an instruction to the selected refuse vehicle 10 (e.g., via the telematics unit and the HMI) to navigate to the location of the customer. By way of another example, in response to receiving an indication that the refuse can 46 was not detected at a stop (e.g., from the sensors 28, from the vision system, etc.), the service manager 52 may select a refuse vehicle 10 in the surrounding area (e.g., within 1 mile, within 5 miles, etc.) and provide an instruction to the selected refuse vehicle 10 (e.g., via the telematics unit and the HMI) to navigate to the location of the customer. By way of another example, the service manager 52 may request for the refuse vehicle 10 to unload the refuse from the refuse compartment 20 at the landfill.

The components of the refuse can detection system (e.g., the refuse vehicle 10, the user device, and/or the service manager 52) may communicate with one another directly and/or across a network (e.g., intranet, Internet, VPN, a cellular network, a satellite network, etc.). In some embodiments, the components of the refuse can detection system communicate wirelessly. By way of example, the refuse can detection system may utilize a cellular network, Bluetooth, near field communication (NFC), infrared communication, radio, or other types of wireless communication. In other embodiments, the refuse can detection system utilizes wired communication.

The network may be communicably coupled to a network interface included in the control system such that the controller is communicably coupled with the network via the network interface, for transmitting and/or receiving data from/to network connected devices. The network allows the controller to communicate with other remote systems. For example, the controller may communicate with a server (i.e., a computer, a cloud server, service manager 52, etc.) to send and receive information regarding operations of the controller, the refuse vehicle 10, the user device, and/or the service manager 52.

The network interface may include any type of wireless interface (e.g., antennas, transmitters, transceivers, etc.) for conducting data communications with the network. In some embodiments, the network interface includes a cellular device configured to provide the controller with Internet access by connecting the controller to a cellular tower via a 2G network, a 3G network, an LTE network, a 5G network, etc. In some embodiments, the network interface includes other types of wireless interfaces such as Bluetooth, WiFi, Zigbee, etc.

The refuse vehicle 10 also includes a data collection system and a vehicle detection system. The refuse vehicle 10 can interface with the user device, the service manager 52, and/or the network. The refuse vehicle 10 can provide information to the user device, the service manager 52, and/or the network. Similarly, the refuse vehicle 10 can receive information from the user device, the service manager 52, and/or the network. The information can include information associated with an indication of a presence or absence of the refuse can 46 at one or more stops along the route 42 and/or other vehicle operations (e.g., emptying the refuse compartment 20, actuating the lift arms 24, and/or other vehicle or vehicle body operations). For example, the refuse vehicle 10 can provide to the service manager 52 a report that indicates which stops (e.g., the past stops) did not have the refuse can 46 placed in the pickup location 50 (e.g., a refuse can was not detected at the stop).

In some embodiments, the data collection system receives vehicle data from the vehicle detection system, the user device, the service manager 52, and/or the network. In some embodiments, the data received can include telematics data. In some embodiments, the data collection system, the user device, the service manager, and/or the network interface using a controller area network (CAN). The data collection system uses the vehicle data (e.g., data gathered from the sensors 28, data gathered form the vision system, etc.) to determine whether the refuse can 46 was placed in the pickup location. For example, the data collection system can receive sensor data from the sensors 28 and image data from the vision system. In some embodiments, the data collection system can assign a GPS location (e.g., received from the GPS system) to any one or more stops (e.g., the past stops) where the refuse can 46 was not present and/or detected at the stop.

In some embodiments, the data collection system includes a communications interface (e.g., network interface), wherein the vehicle detection system can interface with the data collection system through the communications interface. The vehicle detection system may be or include the one or more sensors 28 and/or the vision system.

As described herein, the vehicle detection system (e.g., the sensors 28, the vision system, etc.) may include any type of device that is configured to capture data associated with the detection of objects such as refuse cans and/or obstacles impeding access to a refuse can(s). In this regard, the vehicle detection system may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by the vehicle detection system may include, for example, raw image data from one or more cameras (e.g., visible light cameras) of the vision system and/or data from one or more sensors 28 (e.g., LIDAR, radar, etc.) that may be used to detect objects.

The sensors 28 and/or the vision system may be disposed at any number of locations throughout and/or around the refuse vehicle 10 for capturing image and/or object data from any direction with respect to the refuse vehicle 10. For example, the vehicle detection system may include a plurality of visible light cameras and LIDAR cameras/sensors mounted on the forward and lateral sides of the refuse vehicle 10 for capturing data as the refuse vehicle 10 moves along the route 42. In some embodiments, one or more of the sensors 28 and/or the vision system may be located on one or more components of the refuse vehicle 10, such as the panels, the tailgate 16, the lift arms 24, the grabber arms 36, etc.

The vehicle detection system may generally receive and process data from the sensors 28 and/or the vision system to detect the presence and absence of objects (e.g., refuse cans) proximate to the refuse vehicle. The data received and processed by the vehicle detection system may include any type of data as described above with respect to the vision system, including video from which images and/or other image data can be extracted. As described above, the data may also include data from one or more sensors 28 that may be utilized to detect the presence and absence of an object (e.g., the refuse can 46) and/or a location or position of the object. In some embodiments, the vehicle detection system preprocesses the data from the sensors 28 and/or the vision system before transmitting the data to the data collection system for further processing.

The vehicle detection system may process the received data to detect target objects, including the refuse cans 46. It will be appreciated, however, that the vehicle detection system may be configured to detect other objects based on other implementations of the controller. In this regard, the vehicle detection system may provide means for the controller to detect and track a plurality of the refuse cans 46 on the route 42 being traveled by the refuse vehicle 10. Similarly, the vehicle detection system provides means for the controller to detect and track the absence of a plurality of the refuse cans 46 on the route 42.

The vehicle detection system may be an object detector including a neural network or other similar model for processing received data (e.g., from sensors 28, from the vision system, etc.) to detect target objects. The vehicle detection system may be post-processed (e.g., during training) by implementing automated augmentation and/or stochastic regularization to renormalize newer versions of the vehicle detection system that have been trained using new data. Automated augmentation may include, for example, automatically augmenting image data to produce slightly varied versions of the image data to retrain and improve the vehicle detection system. Said post-processing techniques may improve the performance of the vehicle detection system, for example, by reducing overfitting of the vehicle detection system.

The model implemented by the vehicle detection system may be trained by any number of methods. For example, the vehicle detection system may be trained during manufacture or prior to implementation. In some embodiments, initial training of the vehicle detection system may be handled by a remote system (e.g., a server or computer), and a trained instance of the vehicle detection system may be implemented via the controller. Similarly, the vehicle detection system may be updated or replaced by receiving updated object model data and/or a new version of the vehicle detection system via an over-the-air (OTA) update from the remote system via the network. For example, a new version of the vehicle detection system may be trained on a remote server system and uploaded (i.e., transmitted) to the controller via the network. In this manner, the vehicle detection system may be continuously improved to provide improved object detection.

In some embodiments, the system is configured to determine information associated with the pickup location based on data from the sensors 28. For example, in some embodiments, the refuse cans 46 storing refuse to be collected by the refuse vehicle 10 include a barcode located on one or more outer surfaces of the refuse can 46. The barcode may be positioned on the refuse can 46 in a location where the sensors 28 and/or the vision system can scan the barcode. In some embodiments, the vehicle detection system utilizes the sensors 28 and/or the vision system to scan (e.g., search, track, record, monitor, etc.) the surrounding area of a stop for the barcode. If the vehicle detection system does not receive an indication from the sensors 28 and/or the vision system relating to the presence of the barcode at a stop, the vehicle detection system transmits a signal to the controller indicating the absence of the refuse can 46 at that stop. The controller may then transmit the signal to other refuse vehicles 10, the user device, the service manager 52, and/or the network associated with an indication that the refuse can 46 was not detected (e.g., the refuse can 46 is missing).

In some embodiments, the refuse cans 46 storing refuse to be collected by the refuse vehicle 10 include a Radio Frequency Identification (“RFID”) tag coupled to the refuse can 46. The RFID tag may be positioned on the refuse can 46 in a location where the sensors 28 can detect or otherwise scan the RFID tag. In some embodiments, the vehicle detection system utilizes the sensors 28 and/or the vision system to scan (e.g., search, track, record, monitor, etc.) the surrounding area of a stop for the RFID tag. If the vehicle detection system does not receive an indication from the sensors 28 and/or the vision system relating to the presence of the RFID tag at a stop, the vehicle detection system transmits a signal to the controller indicating the absence of the refuse can 46 at that stop. The controller may then transmit the signal to other refuse vehicles 10, the user device, the service manager 52, and/or the network associated with an indication that the refuse can 46 was not detected (e.g., that the can(s) is missing). It should be appreciated that various other methods for identifying and/or determining data from the refuse can(s) may be used by the vehicle detection system. For example, the system may determine a type of refuse contained within or otherwise associated with the can(s) based on a color of the can(s), a logo on the can(s), a shape of the can(s) or portions thereof, etc. The controller may also use the data collected to determine the waste stream, an owner associated with the can(s), a location associated with the can(s), etc.

Based on the data captured by the vehicle detection system, the HMI may present a generated user interface. The user interface may include data captured by the sensors 28 and/or the vision system (e.g., live, delayed, or previously captured image data) and an indication of any detected objects (e.g., the refuse cans 46) within the data and/or an indication of any absent refuse cans 46 within the data. As an example, the user interface may present an image of the route 42 that refuse vehicle 10 is traveling on, and may indicate one or more detected refuse cans 46 and one or more absent refuse cans 46 located along the route 42 at which a can(s) was expected. An example user interface is described in detail below.

A user interface may illustrate the detection and absence of the refuse cans 46, according to some embodiments. The user interface may be presented to a user of the controller and/or the refuse vehicle 10. The user interface may be presented via the HMI, for example. More generally, the user interface illustrates the detection of refuse can objects from data captured by one or more image and/or object sensors.

In some embodiments, the image of the user interface may represent an input image to the vehicle detection system. The vehicle detection system may be configured to detect any number of object classes, as described above, including at least refuse cans. A first refuse can 46 located at a first pickup location 50 (e.g., a stop along the route 42) may be shown by the user interface to have been detected (e.g., by the vehicle detection system). A second pickup location 50 (e.g., a stop along the route 42) may be shown by the user interface as having been detected (e.g., by the vehicle detection system) without a second refuse can 46 positioned at the second pickup location 50. The first refuse can 46 may be shown with a bounding box, indicating the first refuse can 46 within the user interface and a probability that the bounding box actually contains the detected first refuse can 46. The bounding box for the first refuse can 46 may not only indicate detected objects, but may indicate a location (e.g., first pickup location 50) of the first refuse can 46 within a captured image (e.g., the image presented in the user interface). A second bounding box may indicate a location of the second pickup location 50 where the refuse vehicle 10 and/or the vehicle detection system expect a refuse can 46 to be. The expectation of the refuse can 46 to be placed at the second pickup location 50 may be based on data previously gathered by the vehicle detection system, an indication received from the service manager 52 that a customer has subscribed to the refuse collection service, a particular day of the week when the second pickup location 50 is scheduled for refuse pickup, a request to pick up refuse received from a customer, etc.

The first refuse can 46 may be shown with a confidence value (e.g., 0.999, 0.990, etc.). The confidence value may indicate a level of confidence that the associated bounding box actually contains an object (e.g., the refuse can 46). As described above, objects with a confidence value below a threshold may be ignored. By way of example, when the vehicle detection system detects the pickup location 50 and determines the pickup location 50 has a confidence value lower than the threshold, the vehicle detection system can make a determination that the refuse can 46 is absent from the pickup location 50. In some embodiments, the vehicle detection system transmits a signal associated with a confidence value of the pickup location 50 to the controller. The controller is configured to receive the confidence value and make a determination whether the refuse can 46 is absent from the pickup location 50.

The refuse can 46 may be absent from the second pickup location 50. In response to detecting the absence of the refuse can 46 at a location where the refuse can 46 is expected, the vehicle detection system may send input data (e.g., a signal, a video file, an image file, GPS coordinates, etc.) to other refuse vehicles 10, the user device, the service manager 52, and/or the network associated with an indication that the refuse can 46 was not detected (e.g. missing). The input data transmitted to other refuse vehicles 10, the user device, the service manager 52, and/or the network associated with an indication that the refuse can 46 was not detected may be an image/video file captured by the vision system. The vision system may capture image/video data that contains enough of the surrounding area to confirm a location (e.g., customer address, geographical landmarks, street signs, road markings, etc.) of where the missing refuse can 46 was detected. In some embodiments, the vision system is constantly recording, transmitting, and saving image/video data while the refuse vehicle 10 is traveling along the route 42. In other embodiments, the vision system only records, transmits, and saves image/video data when the vehicle detection system detects an absence of the refuse can 46 (e.g., similar to how a vehicle dash cam saves data during an event such as a car accident).

The vehicle detection system may include a storage database, a data logger, or the like that stores any data points (e.g., data from the sensors 28, data from the vision system, etc.) received from the vehicle detection system. The storage database may include a plurality of telemetry datasets, with each dataset corresponding to a different sensor 28 and/or device of the vision system of the vehicle detection system. Each dataset may include a plurality of entries, with each entry including a sensor data point value and a time stamp. Alternatively, or additionally, the storage database may store vehicle system reports generated via the vehicle detection system. The data captured by the vehicle detection system may be transmitted to other refuse vehicles 10, the user device, the service manager 52, and/or the network to share locations (e.g., stops) that were skipped by the refuse vehicle 10 along its route 42 because the vehicle detection system did not detect the refuse can 46.

The stored data may be removed from the storage database once the data is uploaded to a remote cloud storage. For example, long-term storage of the telemetry data and other data may be done on a centralized server, and the network interface may wirelessly connect with a remote server to transmit and store the data. The data includes a timestamp, a vehicle identifier, and a GPS signal from the GPS system to identify the data in remote server. In some embodiments, the service manager can perform similarly functionality to a remote server.

In some embodiments, the service manager 52 can perform similar functionality to the data collection system and/or the vehicle detection system. For example, the data collected by the vehicle detection system can be provided to the service manager 52. The service manager 52 can use the data to determine whether the refuse can 46 is present or absent at the pickup location 50 or at a stop along the route 42.

The service manager 52 includes a controller that controls operation of the service manager 52. The controller includes a processing circuit and a memory device. The memory device may contain one or more instructions that, when executed by the processor, cause the controller to perform the processes described herein. While some processes may be described as being performed by the controller, it should be understood that those processes may be performed by any other controller of the refuse vehicle 10 and/or the system or distributed across multiple controllers of the refuse vehicle 10 and/or the system.

The service manager 52 further includes a network interface (e.g., a communication interface, etc.) operatively coupled to the controller. The communication interface is configured to transfer data between the service manager 52 and other components of the system (e.g., the refuse vehicle 10, the user device, the network, etc.). The communication interface may facilitate wired and/or wireless communication.

The service manager 52 may receive various inputs (e.g., input data) and provide various outputs (e.g., output data) throughout operation. Specifically, the data is transferred between the service manager 52 and the other components of the system through the communication interface. The data may be stored (e.g., temporarily or permanently) in the memory. The data may be transferred to other components of the system or analyzed by the controller. By way of example, the service manager 52 may utilize multiple sources of data to generate new data that is utilized by the system. In some embodiments, the service manager 52 has greater processing capabilities than the other controllers of the system. Accordingly, it may be advantageous for certain complex calculations to be performed by the service manager 52. In some embodiments, the service manager 52 utilizes advanced calculation techniques, such as artificial intelligence, machine learning, neural networks, etc. The service manager 52 may utilize this enhanced processing ability along with all of the data available within the system to continuously optimize operation of the system (e.g., minimizing customer wait times and energy usage, etc.).

The various input data received by the memory may include data gathered and processed by the vehicle detection system. The data received and processed by the vehicle detection system may include any type of data as described above with respect to the vision system, including video from which images and/or other image data can be extracted. As described above, the data may also include data from one or more sensors 28 that may be utilized to detect the presence and absence of an object (e.g., the refuse can 46) and/or a location or position of the object.

The memory stores location data that indicates a location of one or more users (e.g., customers), the location of one or more user devices, or the location of one or more stops along the route 42 where the vehicle detection system detected the absence of the refuse can 46. The location data may be generated by a location sensor of the user device. By way of example, when the vehicle detection system detects an absence of the refuse can 46 at a stop, a signal is transmitted to the service manager 52 including an indication of the absent refuse can 46 at the stop along the route 42. The service manager 52 may then link (e.g., associate) the signal with the location of the stop having the absent refuse can 46 and store the data as the location data. The location may be a current location of the user device, or the location may be GPS coordinates received from the GPS system at the time the vehicle detection system detected the absence of the refuse can 46.

The service manager may transmit the location data as output data to other refuse vehicles 10 to display (e.g., via the HMI) or otherwise notify an operator of the refuse vehicle 10 of the location of the stop associated with the indication of the absent refuse can 46. The notification may provide instructions to the operator to instructing them to drive along the route 42 at a later time and stop at the past stop associated with the indication of the absent refuse can 46 to determine if the customer has placed their refuse can 46 in the pickup location 50. In some embodiments, the HMI of the user device displays a map including a visual representation of a location of the stop where the absent refuse can 46 was detected.

The memory stores vehicle location data that indicates the location of one or more of the refuse vehicles 10. The vehicle location data may be generated by the GPS system of the refuse vehicle 10 and periodically transferred to the service manager 52. The vehicle location data may provide a real-time or periodic view into the current locations of the refuse vehicles 10. The vehicle location data may facilitate navigation of the refuse vehicles 10 and determining which of the refuse vehicles 10 to assign to a particular route. The vehicle location data may facilitate determining which of the refuse vehicles 10 to transmit instructions to drive past the past stop where the vehicle detection system previously detected the absent refuse can 46. The vehicle location data may provide an indication relating to the number of instances the refuse vehicle 10 has driven past a stop.

The data stored on the memory may be used to train the driver or the operator of the refuse vehicle 10. If the driver of the refuse vehicle 10 passes a refuse can 46 without making a pickup, the HMI may notify the driver that the pickup has been missed. The HMI may provide the driver with options to access one or more menus or sub-menus containing additional information, options for entering information or reasons for the missed pickup (e.g., a section titled “missed can detected—please provide reason for missed pickup,” etc.), and/or a list of training videos that the driver can select to be shown (e.g., how the refuse can 46 is expected to be picked up in that location, etc.).

The memory may store refuse collection requests from customers. The refuse collection requests may originate in the user devices. The refuse collection requests may indicate an identity of the customer requesting the refuse collection, a desired location for the refuse collection (e.g., a location of a future stop or a past stop), a desired timing of the refuse collection, a desired type or amount of refuse to be collected, or other information regarding the refuse collection. By way of example, the user device may monitor the location of the customer through a location sensor, and set the current location of the customer as the future stop.

In some embodiments, the user device runs an application (e.g., a refuse collection hailing application) that facilitates generation of the refuse collection requests by the customer. The application may be stored within a memory of the user device. The application may control a display of the user device to provide a graphical user interface (GUI) that communicates information to the customer and/or receives commands from the customer. By way of example, the customer may interact with elements of the GUI through a touch screen of the user device to generate and/or modify the refuse collection request.

The service manager 52 may generate path data, navigation instructions, or refuse vehicle routes (e.g., the route 42), for the refuse vehicles 10 to use to navigate between stops (e.g., the future stops, the past stops, the pickup locations 50, etc.), neighborhoods 44, and/or the landfills. The route 42 may include a fully formed path (e.g., turn-by-turn directions) for the refuse vehicle 10 to follow. Alternatively, the route 42 may include a request for the refuse vehicle 10 to arrive at a particular stop (e.g., the future stop, the past stop, the pickup location 50, etc.), the neighborhood 44, and/or the landfill. The routes 42 may include instructions that are followed by the operator of the refuse vehicle 10. Alternatively, the routes 42 may include instructions that are followed by an autonomous control system of the refuse vehicle 10.

The memory may store a profile manager configured to receive the GPS data (e.g., GPS coordinates from the GPS system), the sensor data (e.g., LIDAR data, radar data, etc.) from the sensors 28, the image/video data (e.g., pictures, videos, audio files, etc.) from the vision system, and the input data (e.g., a signal relating to a detection that the refuse can 46 is absent from at a pickup location) from the vehicle detection system. The profile manager is configured to use the GPS data, the sensor data, the image/video data, and the input data separately or in combination to determine profiles for the pickup location 50 (e.g., a stop). The profile manager may generate the profile including an identification of whether the refuse can 46 is present or absent, a location of the present or absent refuse cans 46, and their relative distances from the refuse vehicle 10 or positions at the pickup location 50. The profile manager is configured to provide the profile to a profile database for retrieval by the refuse vehicle 10 (e.g., the controller of the refuse vehicle 10), other refuse vehicles 10 when at the location (e.g., the pickup location 50, a stop, a customer site, etc.), the user devices, the service manager 52, and/or the network. In some embodiments, the location is determined by the profile manager automatically when GPS data, the sensor data, the image/video data, and the input data are first obtained at the pickup location 50 (e.g., a stop) indicating that the refuse can 46 is absent. The locations (e.g., stops where the refuse can 46 is absent) may also be defined and set up by the operator when the vehicle detection system provides an indication to the HMI to display a notification notifying the operator of the absent refuse can 46. By way of example, the operator may place a pin on a map displayed by the HMI at a location where the absent refuse can 46 was detected.

The service manager 52 may provide output data to the refuse vehicle 10, other refuse vehicles 10 in a fleet of vehicles or in the surrounding area, the user device, and/or the network. The output data may relate to an identification of one or more particular pickup locations 50 that were detected to have an absent refuse can 46. In some embodiments, the output data may be a signal commanding one or more refuse vehicles 10 to revisit a location that was detected to have the absent refuse can 46. In other embodiments, the output data is transmitted to the user device of the customer notifying the customer that the refuse can 46 was not detected at the pickup location 50 associated with the customer, and therefore their residence was intentionally skipped. In other embodiments, the output data is transmitted to the network to be uploaded to a remote cloud storage. In such embodiments, the user may filter through the output data manually to determine pickup locations 50 where the refuse can 46 was not detected and dispatch the refuse vehicle 10 to stop at that location at a future time to determine if the customer has placed the refuse can 46 in the pickup location 50.

Detecting a refuse can (e.g., the refuse can 46) from captured image and/or object data may be a process implemented by the controller of a refuse vehicle (e.g., the refuse vehicle 10) for detecting one or more refuse cans 46 from data captured by sensors (e.g., the sensors 28) or image devices (e.g., the vision system) disposed at various locations of the refuse vehicle 10. To detect the refuse can 46 from the captured image data and/or the object data, the data is received from one or more of the image and/or object detection devices (e.g., the sensors 28, the vision system, etc.) disposed at various locations of the refuse vehicle 10. In some embodiments, the data is received from at least a visible light camera and a LIDAR camera or sensor. Received data may include raw data from one or more cameras (e.g., visible light cameras) and/or data from one or more sensors (e.g., LIDAR, radar, etc.), as described above. In various embodiments, the data includes still images, video, or other data that can be used to detect the refuse can 10 and a designated pickup location of the refuse can 10. In some embodiments, the received data includes at least raw image data and LIDAR data. The data may be captured from one or more sides of the refuse vehicle 10, in order to detect the refuse cans 46 and/or the pickup locations 50 on either side of a roadway or path that the refuse vehicle 10 traverses.

The raw data received from the one or more sensors 28 may be preprocessed where preprocessing is necessary or desired. In other implementations, it may not be necessary or desirable to preprocess the raw data. Accordingly, in some embodiments, preprocessing of data may be implemented prior to processing the data to detect objects such as the refuse cans 46. In various embodiments, the data may be preprocessed by an imaging device before being transmitted to a controller for image detection, or may be preprocessed by a first system (e.g., a controller, a computer, a server, a GPU, etc.) prior to being received by a second system (e.g., a controller and/or a vehicle detection system) for object (e.g., refuse can 46) and pickup location 50 detection.

In some embodiments, preprocessing the data may include any number of functions based on a particular implementation. For example, preprocessing for a one-stage object detector such as the vehicle detection system may include determining and/or modifying the aspect ratio and/or scaling of received image data, determining or calculating the mean and/or standard deviation of the image data, normalizing the image data, reducing dimensionality (e.g., converting to grey-scale) of the image data, etc. In some embodiments, preprocessing may include determining and/or modifying the image data to ensure that the image data has appropriate object segmentation for utilizing during training (e.g., of the vehicle detection system) and/or object/location detection. In some embodiments, preprocessing may include extracting or determining particular frames of video for further processing.

The data may be input into a vehicle detection system, such as the vehicle detection system as described above. The vehicle detection system may process the data to detect one or more target objects or areas (e.g., the refuse can 46, the pickup location 50, etc.). The output of the vehicle detection system may be an indication of target objects, such as one or more refuse cans 46, an indication of target areas, such as one or more pickup locations 50, and an indication of a confidence level for the detected objects and areas. As an example, the indication of the target objects may include a class of the object (e.g., “refuse can,” etc.) and a confidence level that the bounding box associated with the detected object actually contains the object. Similarly, by way of example, the indication of the target area may include a class of the area (e.g., “pickup location,” etc.) and a confidence level that the bounding box associated with the detected area contains the refuse can 46.

Based on the data, a determination may be made on whether or not the refuse can 46 (e.g., or multiple refuse cans 46) are detected. In some embodiments, the determination is based on the confidence level associated with the detected object (e.g., associated with the bounding box for the detected object). In some embodiments, a confidence level at or above a threshold value may indicated a determination that an object (e.g., the refuse can 46) is detected. A confidence level below the threshold value may indicate a determination that the refuse can 46 is not detected.

If the refuse can 46 is detected, the refuse vehicle 10 may initiate automatic or manual protocols to collect the refuse from the refuse can 46. The protocol may include a number of automatic actions such as operating a lift assembly (e.g., the lift assembly 22, the lift assembly 30) to engage the refuse can 46. The refuse vehicle 10 may also initiate an ejection procedure to dump the refuse stored in a refuse compartment (e.g., refuse compartment 30) at a landfill.

If the refuse can 46 is not detected, a signal is transmitted to other refuse vehicles 10, the user device, a service manager (e.g., the service manager 52), and/or the network relating to an indication that the refuse can 46 was not detected at a particular location. In response to receiving the signal, a response may be initiated. The response may include any number of automated control actions. By way of example, the response may include presenting a notification or indication of the absent refuse can 46 to the operator via the user interface (e.g., the HMI, the user device, etc.). In this example, the operator may be provided with instructions to navigate the refuse vehicle 10 back to the location where the absent refuse can 46 was detected or to provide the system with additional information regarding the missed pickup.

As described above, the refuse can detection system may process the data from the image, video, and/or object systems (e.g., the sensors 28, the vision system, etc.). If a pickup of refuse is missed by the refuse vehicle 10, the refuse can detection system may process the data and store the data. For example, if the refuse vehicle 10 fails to collect the refuse can 46 from the pickup location 50, the refuse can detection system may process, retain, and/or store the data captured at the pickup location 50. The data captured at the pickup location 50 can include images, video, etc. of the pickup location 50 and/or the surrounding area. The data captured at the pickup location 50 may include, for example, captured video of the refuse vehicle 10 passing a location at which a missing refuse can is detected. When the pickup of refuse is missed by the refuse vehicle 10, the data captured at the pickup location 50 may prove that the refuse can 46 was not placed at the pickup location 50 (e.g., the refuse can 46 was missing, the refuse can 46 was in the wrong location, etc.), that there was an obstruction or condition preventing the pickup of the refuse can 46, that the operator of the refuse vehicle 10 inadvertently missed the pickup, etc. The data may be stored on the memory, stored via cloud storage (e.g., within the service manager 52), stored locally temporarily, etc. until it can be uploaded and/or downloaded for review by a user (e.g., the operator, a fleet manager, etc.).

The refuse can detection system may process the data from the image and/or object systems based on certain conditions. For example, the condition may be that an object is present at a location, the object is expected to be present for collection at the location, and the object is not collected. As another example, the condition may be that and object is not present at a location, the object is expected to be present for collection at the location, and the object is not collected. In another example, the condition may be that an object is present at a location and the object is not expected to be present at the location.

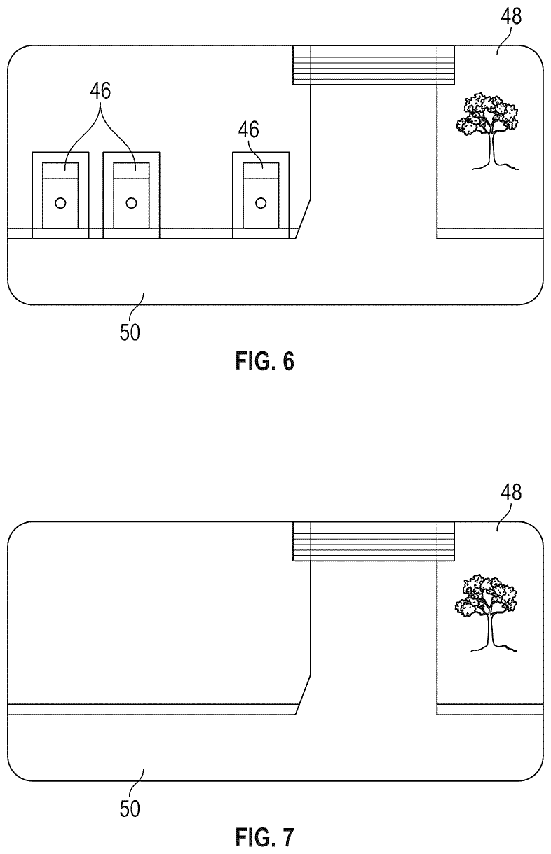

Turning now to FIGS. 6 and 7, exemplary images captured and/or stored by refuse can detection system are shown. As shown in FIG. 6, the refuse can detection system may capture and/or store an image depicting one or more refuse cans 46 present at the pickup location 50. For example, the refuse cans 46 may belong to a verified customer, and the operator of the refuse vehicle 10 has failed to pick up the refuse cans 46 at the pickup location 50, triggering refuse can detection system to capture and/or store the image depicting the refuse cans 46 at the pickup location 50. As shown in FIG. 7, the refuse can detection system may capture and/or store an image depicting no refuse can 46 at the pickup location 50. For example, the pickup location 50 may be located at the customer plot 48 (e.g., the location of a valid customer), and no pickup of refuse occurred at the pickup location 50, triggering the refuse can detection system to capture and/or store the image depicting no refuse can 46 at the pickup location 50. The failure to pick up the refuse can 46 of the verified customer, or the pickup of a refuse can 46 not belonging to a verified customer or located at the customer plot 48, may help identify a correct or incorrect waste stream and may provide data and insight to the waste streams.

The refuse can detection system may provide alerts to the operator and/or the user (e.g., the fleet manager) when the pickup is missed. The refuse can detection system may also provide alerts to the customer when the refuse can 46 associated with the customer is missing from the pickup location 50, the refuse can 46 is obstructed, and/or the refuse vehicle 10 was unable to make a pickup, etc. The alerts may be communicated by the system via text message, email, a notification, a fleet management portal, route planning software, etc. The data processed by the refuse can detection system may be used to verify whether or not a given pickup occurred at the pickup location 50. For example, the user may use the data processed by the refuse can detection system to train the operators of the refuse vehicles 10, increase efficiency or accuracy of the pickup of refuse, provide proof to the customer regarding whether or not the pickup occurred, etc.

### Tracking and Reminder System

According to an exemplary embodiment, a system and method for tracking a refuse vehicle and alerting a user to the refuse vehicle's location to aid in refuse can collection are disclosed herein. The refuse vehicle may be a garbage truck, a waste collection truck, a sanitation truck, etc., configured for side loading, front loading, or rear loading and the like. The refuse vehicle may include a positioning system and/or a route generation/prediction system that includes components such as a global positioning system (GPS) transceiver, a cellular transceiver, inertia sensors, etc., to determine a location and route of the refuse vehicle. A server system may determine, based on the location of the refuse vehicle and the upcoming stops along the route, whether the refuse vehicle is within a geofence established by a customer and whether the refuse vehicle will perform a refuse collection operation at the customer's location within a certain time threshold given the route of the refuse vehicle. When the refuse vehicle enters or exits an area defined by the geofence, and the refuse vehicle is expected to perform a refuse collection operation at the customer's location within the time threshold, an alert may be sent to a device of the customer. In contrast, when the refuse vehicle is likely to enter or exit an area defined by a geofence, and the refuse vehicle is not expected to perform the refuse collection operation at the customer's location within the time threshold, no alert may be sent to the device of the customer. In this way, the systems and methods disclosed herein may alert a specific customer that a refuse vehicle is on the way (e.g., will soon arrive, will arrive to collect refuse within a predefined time period, etc.) at their location and provide a reminder, alert, or otherwise notify the customer to place their refuse containers in a designated location for collection.

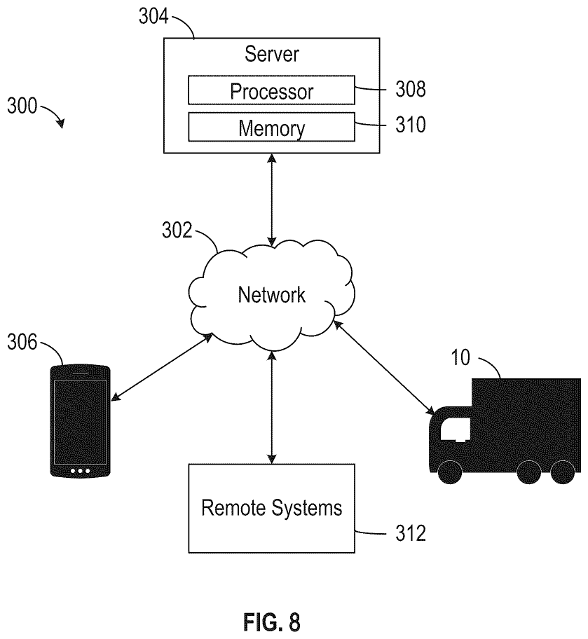

Referring now to FIG. 8, a tracking and alert system 300 for refuse can collection is shown, according to some embodiments. System 300 may track (e.g., determine, predict, estimate, or otherwise calculate) a location of a refuse vehicle 10 as it operates, such as while the refuse vehicle 10 traverses a refuse can collection route. System 300 may alert a customer (e.g., an individual, household, business, etc. having a refuse can) to the location of refuse vehicle 10 when refuse vehicle 10 enters and/or approaches an area defined by a geofence. The area defined by the geofence may be set by the customer, a refuse collection service provider, a municipality, etc. In this manner, the customer may be alerted when refuse vehicle 10 is within a certain proximity of a location set by the customer (e.g., the customer's location or a location of the customer's refuse can(s)). Further, the system 300 may determine or receive a planned refuse can collection route indicative of one or more upcoming refuse can collection operations of the refuse vehicle 10. Specifically, the system 300 may determine whether the refuse vehicle 10 will arrive or perform a refuse collection operation at the location of the customer within a designated time period (e.g., a reminder time threshold). If, based on the planned refuse can collection route, the refuse vehicle 10 will collect refuse at the customer's location within the time period, the system 300 may send a notification such as a reminder to the customer to place their refuse cans in a location for collection.

Accordingly, the customer may place the refuse can so that it may be retrieved and/or emptied by refuse truck 10 in an appropriate position once the customer receives the notification (e.g., a message, an alert, etc.). Additionally, the system 300 may determine that the customer's refuse has already been collected that day and determine not to send a notification based on the previous collection operation. Further, the system 300 may determine that the refuse vehicle 10 will not perform a refuse collection operation at the customer's location within the time period (e.g., even though the refuse vehicle 10 is geographically proximate to the customer's location, the planned route does not include the customer's location for at least another hour, three hours, five hours, or will not stop at the customer's location, etc.). Accordingly, the system 300 may determine, in response to the refuse vehicle 10 being scheduled to arrive at the customer's location at an arrival time exceeding the reminder time threshold, not to send a reminder, alert, or notification to the customer (e.g., a customer designates that a reminder be sent when the refuse vehicle 10 is an hour away from the customer's location, however the refuse vehicle is an hour and ten minutes, two hours, etc. away from the customer's location and therefore no notification is sent until the refuse vehicle 10 is an hour or less away from the customer's location).

System 300 is shown to include a network 302. Network 302 may be any type of network (e.g., a VPN, WAN, LAN, etc.) that allows the components of system 300 to communicate remotely. In communication with network 302 is a server 304, a user device 306, and refuse vehicle 10. Each of server 304, user device 306, and refuse vehicle 10 may include a wired or wireless network interface (e.g., an antenna, a transmitter, a transceiver, etc.) for conducting data communications with network 302. In some embodiments, the network interfaces of each of user device 306 and/or refuse vehicle 10 may include a cellular device configured to provide Internet access by connecting to a cellular tower via a 2G network, a 3G network, an LTE network, etc. In some embodiments, network interfaces may include other types of wireless interfaces such as Bluetooth, WiFi, Zigbee, etc. As an example, server 304 may include a wired network interface to communicate with network 302 and user device 306 may include a cellular and/or WiFi network interface. It will be appreciated that each of server 304, user device 306, and refuse vehicle 10 may include a different type of network interface.

Server 304 may be any remote computing system (e.g., a computer, a cloud server, etc.) having at least a processor 308 and a memory 310. Processor 308 may be coupled to memory 310. Processor 308 may be a general purpose or specific purpose processor, an application specific integrated circuit (ASIC), one or more field programmable gate arrays (FPGAs), a group of processing components, or other suitable processing components. Processor 308 is configured to execute computer code or instructions stored in memory 310 or received from other computer readable media (e.g., CDROM, network storage, a remote server, etc.).

Memory 310 may include one or more devices (e.g., memory units, memory devices, storage devices, etc.) for storing data and/or computer code for completing and/or facilitating the various processes described in the present disclosure. Memory 310 may include random access memory (RAM), read-only memory (ROM), hard drive storage, temporary storage, non-volatile memory, flash memory, optical memory, or any other suitable memory for storing software objects and/or computer instructions. Memory 310 may include database components, object code components, script components, or any other type of information structure for supporting the various activities and information structures described in the present disclosure. Memory 310 may be communicably connected to processor 308 and may include computer code for executing (e.g., by processor 308) one or more of the processes described herein.

In some embodiments, server 304 may include (e.g., host) one or more application programming interfaces (API) for processing geofence data received from a user device, tracking refuse vehicle 10, and/or transmitting notifications to user device 306. For example, server 304 may host at least a geofencing API and an API configured to generate and transmit notifications to user device 306.

User device 306 may be any electronic device that allows a user to transmit and/or receive information or other data via network 302. Examples of user devices include, but are not limited to, mobile phones, electronic tablets, laptops, desktop computers, workstations, and other types of electronic devices. Generally, user device 306 may include at least a display for presenting information to a user and a user input device for receiving user inputs. The user input components of user device 306 may include, for example, a keyboard, buttons, a touchscreen, etc. In one example, user device 306 is a smart phone having a touchscreen display configured to present an application or other user interface for establishing a geofence and/or designating a reminder time threshold (e.g., an option to select how soon the refuse truck will arrive at the customer's location before sending a warning, alert, reminder to place refuse containers in a collection location).

In some embodiments, a user of user device 306 (e.g., a customer of a refuse collection provider having a refuse can) may input one or more parameters to define a geofence around a particular location. A geofence is a virtual boundary that defines a perimeter around a physical (e.g., geographical) location. In other words, the geofence data inputted by the user defines a virtual boundary around an area or location specified by the user. For example, the user may input a perimeter around the user's home address to define the geofence. The user may input geofence data (e.g., geofence parameters) via a user interface of user device 306, for example. In one example, the user may establish a geofence around a location where a refuse can is stored (e.g., the home address of the user). In some embodiments, the user may input a geofence and/or geofence data via an application on a computer or smart phone, via a website, or by any other appropriate means. For example, a user may define an outline/overlay over an image of a map showing their location, may define a region bounded by specific streets or encompassing specific blocks, or may select one or more predefined geofences associated with a region or municipality. For example, a predefined geofence may include the area within and around a designated school district, an area within a certain number of related streets (e.g., an area between 1^{st} Street and 10^{th} Street), or an area defined by a subdivision, suburb, or other named area (e.g., a specific borough of New York City, a specific town or suburb located near/in Dallas, etc.).

In some embodiments, the user of user device 306 may be presented with a map of an area around a particular location, and the user may draw or otherwise indicate a perimeter (e.g., boundary) of the geofence. In other embodiments, the user may enter a geofence parameter (e.g., time, distance, miles, number of stops, etc.) from the customer's particular location. In yet other embodiments, any other known or appropriate means for establishing a geofence may be used. The geofence data may be transmitted from user device 306 to server 304. Subsequently, server 304 may store the geofence data in memory 310 and/or process the geofence data via processor 308. Processing the geofence data may include generating a geofence from received geofence data (e.g., parameters) and/or storing a generated geofence or geofence data in memory 310.

While in operation, the location of refuse vehicle 10 may be tracked and/or predicted by server 304. Generally, the location of refuse vehicle 10 may be tracked and/or predicted by server 304 by any suitable or known method. As an example, a GPS transceiver and/or controller of refuse vehicle 10 may determine the location of refuse vehicle 10 and/or future stops of the refuse vehicle 10, and the location may be transmitted (e.g., via a GPS connection, via a cellular network, etc.) from refuse truck 10 to server 304. Based on the location of refuse vehicle 10 and a route of the refuse vehicle 10, server 304 may determine whether refuse vehicle 10 is within/approaching the geofence (e.g., has crossed a boundary of the geofence, will soon cross the boundary of the geofence) established by the user and an approximate arrival time, if any, that it will take the refuse vehicle 10 to arrive at the customer's location to perform a refuse collection operation.

In the event that server 304 determines that refuse vehicle 10 is within the geofence and/or will arrive at the customer's location within a predefined time, the server 304 may generate and transmit a notification (e.g., an alert, a reminder, a text message, an email, etc.) to user device 306. In this regard, the notification may indicate to the user that a refuse collection vehicle will arrive within a specified time period and/or is within a specified proximity of the user's location (e.g., within a given distance of the user's refuse container). In one example, the user may receive (e.g., via user device 306) a push notification or a text message that notifies the user that the refuse vehicle is in their area and an approximate time of arrival of the refuse vehicle 10. In another example, the notification may indicate how close the refuse vehicle is to the user (e.g., in miles, in number of stops, etc.).

In some embodiments, when refuse vehicle 10 completes a refuse collection operation at the customer's location, subsequent movement within the geofenced area (e.g., when refuse vehicle 10 crosses a boundary of the geofence a second time) or when the refuse vehicle enters the proximity of the location a second time, the server 304 may not generate and may not transmit a second notification to user device 306. In this way, the server 304 may avoid sending multiple and/or duplicative notifications. In other embodiments, the server 304 may indicate to the user that refuse truck 10 has left the geofence area within a predefined time period of arrival, thereby notifying the user that they may retrieve their refuse can from a curb, a street side, or other location where the refuse can is placed for pickup.

In some embodiments, server 304 can also communicate with remote systems 312, which may include any system or device related to the tracking of refuse collection vehicles, as described herein. For example, remote systems 312 may include computing devices such as laptop or desktop computers, mobile phones, additional servers, etc. In some embodiments, remote systems 312 can include an access control system configured to control access to a location, such as a building, a parking lot, a storage area, etc. In some such embodiments, the access control system may be configured to control a gate, door, etc., that secures a refuse can containment area. A refuse can containment area may be a secure area for containing (e.g., housing) one or more refuse cans. For example, the refuse can containment area may be a garage or an open lot containing one or more refuse cans.

In some embodiments, server 304 may transmit commands to the access control system to cause an access control device (e.g., an electronic lock, a motor, an actuator, etc.) to actuate, thereby allowing access to the refuse can containment area. For example, the command may cause access control system to actuate an electronic lock to allow access to the refuse can containment area. In another example, the command may cause access control system to actuate a motor to open a gate, thereby allowing access to the refuse can containment area. In some embodiments, a user (e.g., of user device 306) can define a distance from a particular location (e.g., a location of the refuse can containment area) at which the server 304 transmits commands to the access control system. Thus, in some such embodiments, the user may establish a second geofence for allowing access to the refuse can containment area, which may be similar in area to a first geofence for notifying the user that a refuse collection vehicle (e.g., refuse vehicle 10) is nearby. In other such embodiments, the second geofence may be smaller and/or may be contained within the first geofence. For example, the user may be notified when refuse vehicle 10 crosses a boundary of the first geofence (e.g., a few miles from a target location, an hour from the target location), and an operator of refuse vehicle 10 may be granted access to the refuse can containment area when crossing a boundary of the second geofence (e.g., a hundred feet from a target location). In this manner, the refuse can containment area may remain secured until refuse vehicle 10 is nearby, within sight of the refuse can containment area, and the like.

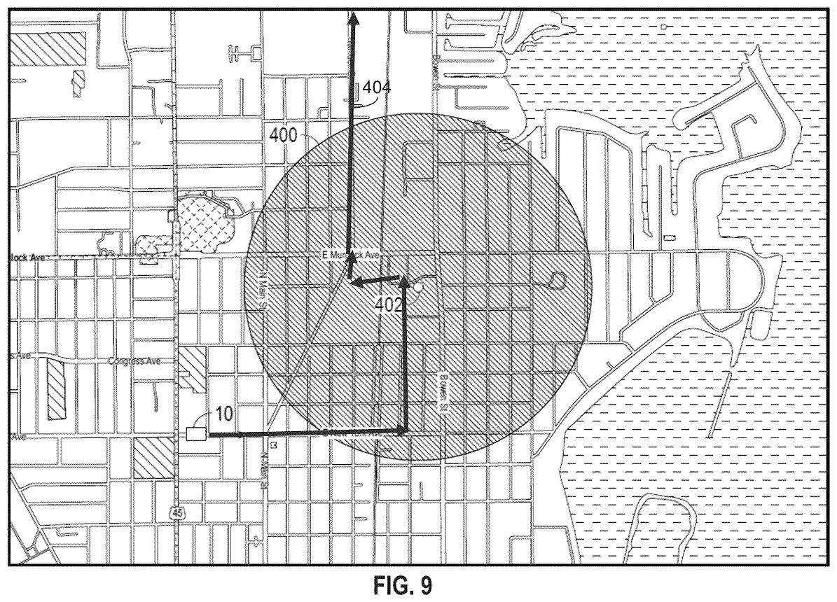

Referring now to FIG. 9, an example of a geofence 400 is shown, according to some embodiments. Geofence 400 is shown as a substantially circular geofence that surrounds a location 402 set by a user (e.g., a user's home address), shown on a map of an area around location 402. The location 402 may include or designate a refuse collection location such as a point, area, and/or geographic space where a refuse vehicle 10 should collect refuse for the user. In this example interface, geofence 400 may have been generated based on geofence data input by the user by specifying a distance from location 402 (e.g., 2-miles around a refuse collection location), where the boundary of geofence 400 is a radius from location 402. As shown in FIG. 9, refuse truck 10 may be tracked as it travels along a roadway or other path. Further, a route 404 associated with the refuse truck 10 may indicate future refuse collection stops or an intended path of travel or order of refuse collection operations/stops for the refuse vehicle 10. As shown in FIG. 9, the route 404 indicates that the refuse truck 10 will enter the geofence, proceed along Bowen Street towards the location 402, take a left towards the location 402, before leaving the geofenced area towards the top of the page. When refuse truck 10 approaches the boundary of geofence 400 (e.g., enters the geofenced area, a route 404 of the refuse vehicle overlaps with the geofenced area, etc.), the system 300 may determine (e.g., estimate, calculate, or otherwise receive) an arrival time. The arrival time may indicate a length of time (e.g., 30 minutes, approximately 50 minutes, over two hours, etc.) or a time of arrival (e.g., by 3:00 P.M., etc.) that the refuse truck 10 will arrive at the location 402 (e.g., the collection location) to perform a refuse collection operation. The system 300 may also receive a reminder time threshold. The reminder time threshold may be predefined in the memory 310 or may be designated by the user via the user device 306. The reminder time threshold determines how close the refuse truck should be to the location before the system will send an alert to the user device 306 (e.g., how soon the refuse truck will arrive at the location 402, how far in advance a notification/reminder should be sent to a user). Based on a comparison of the time, distance, etc. defining the reminder time threshold and the arrival time, the system 300 may determine whether to send a notification to a device of the user (e.g., by server 304). System 300 may make the determination based on data indicative of a refuse collection route of the refuse vehicle 10.

Additionally, the system 300 may determine that a notification has already been sent to a device of the user and/or that a refuse truck 10 has already collected refuse at the location 402. Accordingly, the system 300 may determine not to send a notification to the device of the user, even if it is approaching the location 402, based on a determination that refuse has already been collected at the location 402. In this way, the system 300 may determine that the vehicle 10 has collected refuse at the location of a specific customer (e.g., at the location 402) and that a duplicative notification is not needed. The system 300 may store, log, or keep track of the refuse collection operation at location 402 (e.g., in the memory 310) for a designated time period (e.g., one day, one week, one refuse collection cycle, etc.). Accordingly, the system 300 may determine not to send a notification to a device of the user in response to the vehicle 10 approaching the location 402 a second time because refuse has already been collected at the location 402 and an additional alert, reminder, text, etc. is not necessary twice on the same day, within a predetermined duration, etc.

While a circular geofence defining a radius of a particular distance from location 402 is shown in FIG. 9, it will be appreciated that the geofence may be defined by any number of parameters. For example, a user may specify a distance from a location based on typical driving times or distances via known roadways (e.g., rather than a straight-line distance). Accordingly, the geofence may not necessarily be substantially circular, as shown in FIG. 9, but may take any shape (e.g., any polygonal shape). For example, the geofence may be defined by one or more straight lines such as roadways or other boundaries. In another example, a user may establish a geofence based on a number of stops that the refuse vehicle 10 is from the user's location. In such embodiments, the geofence may not necessarily be presented as an overlay to a map.

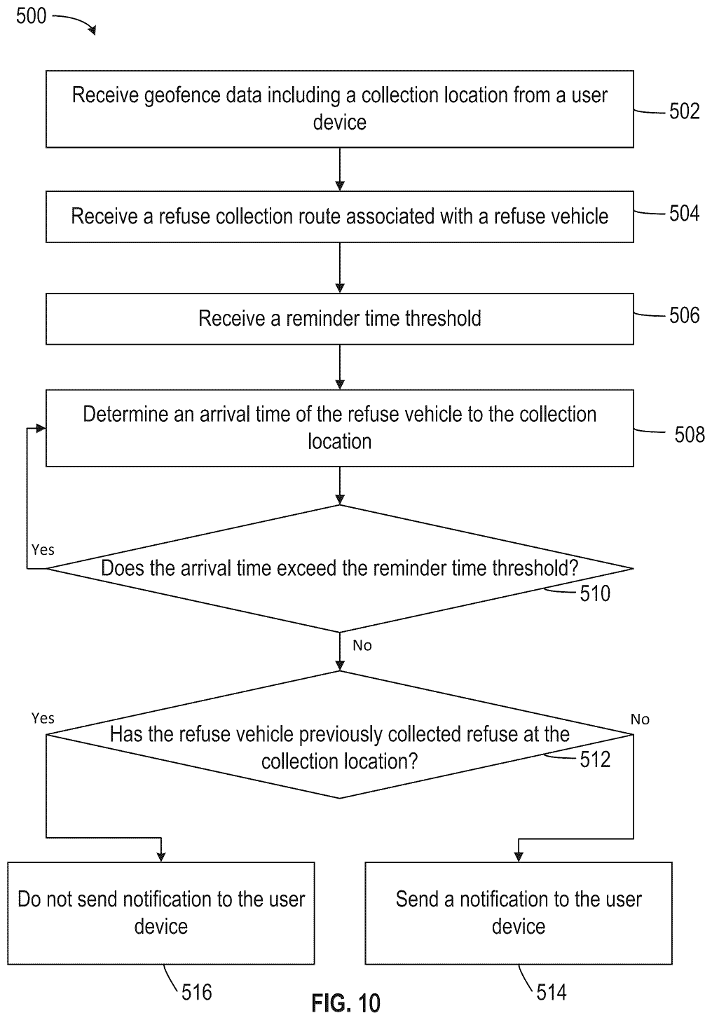

Referring now to FIG. 10, a process 500 for tracking a refuse vehicle and alerting a user for refuse can collection is shown, according to some embodiments. Process 500 may be implemented by system 300, for example. Process 500 may alert a user when a tracked refuse vehicle (e.g., refuse vehicle 10) is within a particular time of arrival, distance, or proximity of a location specified by the user to facilitate the placement and/or retrieval of a refuse can by the user. It will be appreciated that the steps of process 500 are not intended to be limiting, such that process 500 may include more or fewer steps that those shown and that the steps of process 500 may be carried out in any order, may be repeated, or may be modified and still fall within the scope of this disclosure (e.g., the process 500 may be modified such that the system 300 is configured to send a notification to a user device if the arrival time meets or falls below the reminder time threshold).

At step 502, geofence data is received from a user device. The geofence data may include a location, geographic boundary, etc. designating a collection location where refuse cans are located for pick up by a refuse vehicle 10. The collection location may be as general as an address, an area or tract of land, or may be specific (e.g., within a five-foot square perimeter, at the end of a designative driveway, at a location marked with a point/pin/marker, etc.). As described above with respect to FIG. 8, for example, the geofence data may be received by server 304 or another computer system from user device 306 (e.g., via network 302). In some embodiments, the user may input geofence data via an application on a computer or smart phone, via a website, etc. For example, the user may access a web portal where the user subscribes to receive a reminder when a refuse truck is a designated, selected, or predetermined time away from their property/collection location/etc. In this way, the system 300 may broadcast a reminder (e.g., a text message, an email, an automated call, etc.) to the customer when the refuse vehicle 10 is approaching their location to remind them to put the refuse container at the collection location. As described above, for example, the user may be presented with a map of an area around a particular location or a central point, and the user may draw or otherwise indicate a boundary that defines a geofence. To continue this example, the user may enter an address (e.g., a home address) and a user interface may be presented with a map of the area around the address. The user may then enter a distance (e.g., miles, time, etc.) such as by entering a number, moving a slide or other graphical element, drawing a boundary, or by any other appropriate means.

In some embodiments, the user may not be presented with a map of the area but may be able to enter a reminder time threshold, reminder time of day, reminder distance, or other data that defines a time period, distance, or proximity of the refuse vehicle 10 from the particular location (e.g., location 402). For example, the user may selectively turn on a setting of an application that alerts the user when a refuse vehicle is within a predefined arrival time of the user's location. After receiving the geofence data, the geofence data may be processed by the server or computer system (e.g., server 304 of system 300). Processing the geofence data may include generating a geofence from parameters received from the user device, for example. The geofence may then be stored by the server. In some embodiments, a user may define multiple geofences or may access a previously stored or entered geofence to modify parameters of the geofence. For example, the user may change a distance (e.g., a radius) of the geofence or may change a location (e.g., an address) that the geofence is centered on.

At step 504, the system 300 receives data indicative of a refuse collection route 404 associated with a refuse vehicle 10. For example, the data indicative of the refuse collection route 404 may be generated, created, or stored on one or more navigation systems in communication with the refuse vehicle 10. In some embodiments, the data indicative of the refuse collection route 404 may include data from a positioning system that includes components such as a global positioning system (GPS) transceiver, a cellular transceiver, inertia sensors, etc. In this way, the process 500 may include determining, by the system 300, a location and upcoming route of the refuse vehicle 10. For example, a server system may determine, based on the location of the refuse vehicle and the upcoming stops along the route, the refuse collection route of the refuse vehicle 10. In other embodiments, a refuse collection vehicle 10 may have a predefined, fixed, or otherwise designated daily route that may be stored or received by the memory 310.

In other embodiments, the data indicative of a refuse collection route 404 may be determined based on a location of a refuse vehicle (e.g., refuse vehicle 10). In some embodiments, the location of the refuse vehicle 10 is tracked by a server (e.g., server 304) or computer system of a tracking and alert system, such as system 300. It will be appreciated that any number of known methods may be used to determine the location of the refuse vehicle 10 and estimate or approximate a route 404 on which the refuse vehicle 10 will collect refuse. In some embodiments, the location of the refuse vehicle 10 may be determined based on current or historical GPS data received from the refuse vehicle 10 by the tracking and alert system 300. In this regard, a GPS transceiver of the refuse vehicle 10 may determine a location of the refuse vehicle 10 and transmit the location to the tracking and alert system via a network connection (e.g., a cellular connection). In some embodiments, GPS data may be used in combination with other data (e.g., inertial data indicating movement of the refuse vehicle, ultra-wideband data associated with the refuse vehicle 10, etc.) to determine a location and/or trajectory of the refuse vehicle 10.

At step 506, a reminder time threshold is received from a user device. The reminder time threshold may include data designating a minimum time of arrival between the refuse vehicle 10 and the collection location (e.g., location 402) above which the system will not send a notification to the user device. For example, a user may designate a reminder time of one hour via a user interface of the user device. Accordingly, the system 300 will not send a notification to the user device until a refuse vehicle 10 is expected to collect refuse at the location 402 at or within the next hour (e.g., if a refuse vehicle is 2 hours away or an hour and a half away, the system will not provide a notification to the user device). The reminder time threshold may include a minimum time until arrival, may include limitations on specific times to send notification (e.g., only send notifications if the refuse truck 10 will arrive between 2:00 pm and 5:00 pm), may include a countdown timer, or another suitable measurement to notify a user of an upcoming refuse collection operation at their location 402.

At step 508, the system 300 may determine, estimate, predict, or otherwise receive an arrival time of the refuse vehicle 10 to the collection location 402. In this way, the system 300 may determine an approximate duration until a refuse collection operation at the location 402 (e.g., the refuse vehicle 10 will arrive at the location 402 in 20 minutes, 1 hour, 2.5 hours, will not arrive at the location 402 today, etc.). In other embodiments, the arrival time may include a specific time or time frame (e.g., at 2:00 pm, within 15 minutes of noon, before sundown, etc.). The system 300 may use any known methods to estimate, calculate, predict, or determine the arrival time. For example, the system 300 may consider the data indicative of the route of the refuse vehicle 10, local speed limits, estimated arrival time from applications or navigation systems associated with the refuse vehicle 10, previous arrival times at the same or similar locations, traffic patterns, weather conditions, and other suitable considerations.

At step 510, the system 300 determines whether the arrival time of the refuse vehicle 10 at the location 402 (e.g., the collection location for a user) exceeds the reminder time threshold. As shown in FIG. 10, when the arrival time exceeds the reminder time threshold, the process 500 may wait a designated period of time before recalculating the estimated arrival time. For example, the system 300 may determine that the refuse vehicle 10 will arrive at the collection location 402 in two hours. A user may designate a reminder time threshold of one hour before arrival. The system 300 may compare the arrival time to the reminder time threshold, determine that the two-hour arrival time exceeds the one-hour reminder time threshold, and wait an additional hour before determining whether to send a notification to the user device. In some embodiments, the system 300 may count down a time until the reminder time threshold, may refresh the estimated/determined arrival time periodically (e.g., every 5 minutes, every 2 minutes, every 10 minutes, etc.), may determine an arrival time after each stop/refuse collection operation, or the like.

The determined arrival time of the refuse vehicle 10 may be based on a determination of the geofence stored by the tracking and alert system 300 and/or received from the user device and whether the route 404 of the refuse vehicle 10 overlaps or is within the geofenced area (e.g., whether the refuse vehicle 10 is expected to cross a boundary of the geofence or the perimeter established by the geofence at a point in time along the route 404). In the event that the refuse vehicle 10 is expected to cross into the geofence boundary or enter the geofenced area, the system 300 may track or estimate a location of the refuse vehicle 10 and determine a time of arrival, if any, at the location 402 (e.g., the collection location associated with a user). Once the arrival time of the refuse vehicle 10 at the collection location 402 meets or falls below the reminder time threshold, process 500 may continue to step 512.

At step 512, based on a determination that the refuse vehicle 10 will arrive at the collection location or enter a certain proximity of the collection location (e.g., within 50 feet, within one block, within 100 yards, etc.) within the geofenced area, the system 300 may determine whether the refuse vehicle 10 has already collected refuse at the collection location 402. For example, the system 300 may store data indicating that refuse was collected earlier in the day at the collection location 402 in the memory 310. If the system 300 determines that refuse was previously collected at the refuse collection location 402 within a designated time period (e.g., on the same day, etc.), the process 500 may proceed to step 516. At step 516, the system 300 determines and/or does not send a notification (e.g., a reminder, an alert, a text message, etc.) to the device of the user. In this way, the system 300 avoids sending multiple or duplicative reminder messages to a user when the refuse vehicle 10 passes by or proximate to their location but has already collected refuse (e.g., does not stop a second time) at the collection location 402.

However, if the system 300 determines that the refuse vehicle 10 has not previously collected refuse at the collection location 402, the process 500 may proceed to step 514. At step 514, a notification is transmitted to the user device. As described above, the notification may be transmitted to user device 306 from server 304, in some embodiments. The notification may inform the user that the refuse vehicle is within the geofenced area and indicate that the refuse vehicle 10 is within a user-specified time of arrival of a particular location set by the user (e.g., the user's home address, collection location 402, etc.). In one example, the notification may indicate that the refuse vehicle 10 will likely arrive at the collection location within the next hour. Additionally, the notification may include a reminder to place refuse cans at the collection location 402, may provide a countdown to place cans at the refuse collection location 402, may provide an estimated arrival time of the refuse vehicle 10, or provide another suitable reminder regarding the time, duration, or proximity of the refuse vehicle 10 before the user must place their refuse cans out for collection. Accordingly, the user may place the refuse can in a pickup location (e.g., at a curb, at a side of a roadway, etc.) in response to receiving the notification. In another example, the notification may indicate the distance that the refuse truck is from the user's location, such as in miles, time (e.g., minutes), number of stops, etc. In various embodiments, the notification may be sent as a text message, an email, a push notification, an automated voice call, or by any other suitable method.

In some embodiments, at step 514, a command may also be transmitted to an access control system for a refuse can containment area. The command may cause an actuator (e.g., a door actuator, a gate actuator, a motor, an electronic lock, etc.) to facilitate access to a refuse can containment area at a predefined time period. For example, the command may cause an electronic lock to be disengaged at the estimated arrival time of the refuse vehicle 10, allowing access to the refuse can containment area to retrieve a refuse can. As another example, the command may cause a motor coupled to a gate to be activate, opening the gate and allowing access to the refuse can containment area to retrieve the refuse can when the refuse vehicle 10 is within a predefined distance of the refuse collection location 402. Accordingly, a second notification may be sent to alert the user that the refuse vehicle 10 has arrived and has accessed the refuse collection location 402. In some embodiments, a third notification may be sent once the refuse vehicle 10 reaches a subsequent distance away from the refuse collection location 402 to notify the user that the refuse collection operation is complete.

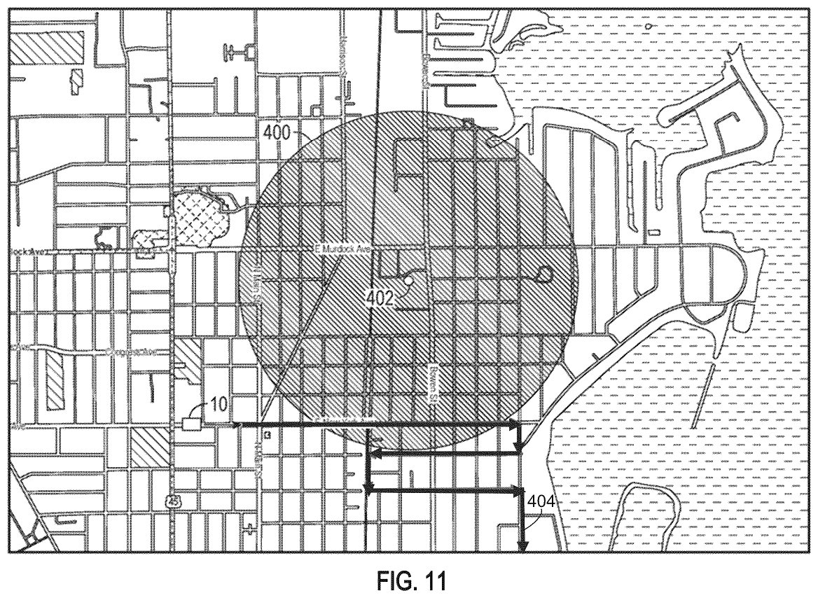

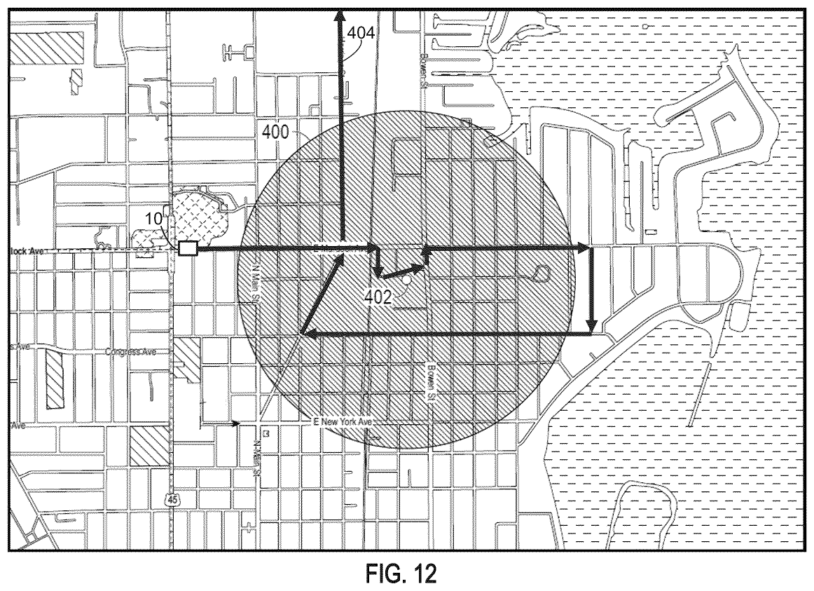

Referring now to FIG. 11, an example diagram of the geofence of FIG. 9 is shown, wherein a refuse vehicle 10 has a route that does not include a specific customer's location, according to an exemplary embodiment. As shown in FIG. 11, the system 300 may receive geofence 400 data associated with the location 402 of a customer. The system 300 may also receive data indicative of a route 404 of the refuse vehicle 10. As illustrated, the route 404 enters the geofence 400 area, but does not stop at the location of the customer (e.g., the refuse collection location 402). Accordingly, the system may receive a reminder threshold time of one hour, indicating that a notification should be sent from the system when the refuse vehicle 10 is approximately 1 hour away from collecting refuse at the location 402. However, given the data indicative of the route 404 in FIG. 11, the system 300 may determine that the arrival time is greater than 24 hours, that there is no arrival time, that the refuse vehicle 10 will not arrive at the location 402 before the reminder threshold time, etc. Accordingly, at step 510, no notification is sent from the system 300 to the user device despite the vehicle 10 entering and exiting the geofence 400 and entering a geographic region associated with the location 402. In this way, the system 300 may be configured to send a notification to a user device upon determining that the refuse vehicle 10 will, within a designated duration/time period, perform a refuse collection operation at the location 402.

Referring now to FIG. 12, an example diagram of the geofence of FIG. 9 is shown, wherein a refuse vehicle 10 has a route that includes a specific customer's location, causes the refuse vehicle 10 to exit the geofence, then re-enter the geofence and again enter the proximity of the customer's location, according to an exemplary embodiment. As shown in FIG. 12, the system 300 may receive geofence 400 data associated with the location 402 of a customer. The system 300 may also receive data indicative of a route 404 of the refuse vehicle 10. As illustrated, the route 404 enters the geofence 400 area, includes a stop at the location 402 of the customer (e.g., the refuse collection location 402). Accordingly, the system 300 may receive a reminder threshold time of 30 minutes, indicating that a notification should be sent from the system 300 when the refuse vehicle 10 is approximately 30 minutes away from collecting refuse at the location 402. Given the data indicative of the route 404 in FIG. 12, the system 300 may determine a location along the route 404 before reaching the refuse collection location 402 wherein the arrival time is approximately or less than 30 minutes. Accordingly, at step 510, the system 300 may send a notification to the user device notifying the user to place their refuse cans outside in light of the impending refuse collection operation. After collecting the refuse, the refuse vehicle 10 may continue along the route 404 and may, for example, leave the geofence 400, re-enter the geofence 400, and/or circle back or other re-approach the location 402. However, at step 512, the system 300 may determine that the refuse collection vehicle 10 has previously collected refuse at the location 402 (e.g., that a refuse vehicle 10 has already sent a notification associated with the location 402 within the past 12 hours, within the same day, by the same or a different refuse vehicle 10, etc.). In this way, the system 300 may prevent a duplicative notification from being sent to a user device upon determining that the refuse vehicle 10 has, within a designated duration/time period, already performed a refuse collection operation at the location 402.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for verifying refuse collection, the system comprising:
a camera system coupled to a refuse vehicle and configured to detect an object proximate to the refuse vehicle; and
one or more memory devices storing instructions thereon that, when executed by one or more processors, cause the one or more processors to:
receive image data from the camera system;
transmit the image data to an object detection system;
determine, based on stored data, whether the object is expected to be present for collection at a location; and
based on determining that the object is expected to be present for collection at the location, instruct the camera system to store an image of the location on the one or more memory devices.

2. The system of claim 1, wherein the object is a refuse can.

3. The system of claim 1, wherein the instructions further cause the one or more processors to:
based on an output from the object detection system, determine whether the object is present at the location; and
determine whether the object is collected.

4. The system of claim 1, wherein the one or more processors instruct the camera system to store the image of the location based on determining at least one of:
the object is present at the location, the object is expected to be present for collection at the location, and the object is not collected;
the object is not present at the location, the object is expected to be present for collection at the location, and the object is not collected; and
the object is present at the location and the object is not expected to be present at the location.

5. The system of claim 1, wherein the instructions further cause the one or more processors to store data relating to collection of the object, the data comprising at least in part a determination of whether or not the object is collected.

6. The system of claim 5, wherein the instructions further cause the one or more processors to, based on a determination that the object is not collected, provide a driver of the refuse vehicle with one or more options relating to the data.

7. The system of claim 6, wherein the one or more options comprise a menu containing additional information, an option for entering information, or a training module.

8. The system of claim 1, wherein the instructions further cause the one or more processors to transmit a notification to a driver of the refuse vehicle.

9. A method for verifying refuse collection, the method comprising:
receiving image data from a camera system coupled to a refuse vehicle;
processing the image data by inputting the image data into an object detection system; and
determining one or more of:
based on stored data, whether an object is expected to be present for collection at a location; and
based on determining whether the object is expected to be present for collection at the location, instructing the camera system to store an image of the location on a memory.

10. The method of claim 9, wherein the object is a refuse can.

11. The method of claim 9, wherein instructing the camera system to store the image of the location is based on determining at least one of:
the object is present at the location, the object is expected to be present for collection at the location, and the object is not collected;
the object is not present at the location, the object is expected to be present for collection at the location, and the object is not collected; and
the object is present at the location and the object is not expected to be present at the location for collection.

12. The method of claim 9, further comprising storing data relating to collection of the object, the data comprising at least in part a determination of whether or not the object is collected.

13. The method of claim 12, further comprising, based on a determination that the object is not collected, providing a driver of the refuse vehicle with one or more options relating to the data.

14. The method of claim 13, wherein providing the driver of the refuse vehicle with one or more options relating to the data comprises providing the driver with a menu containing additional information, an option for entering information, or a training module.

15. The method of claim 9, further comprising transmitting a notification to a driver of the refuse vehicle.

16. A refuse vehicle, comprising:
a camera system configured to detect an object proximate to the refuse vehicle; and
one or more memory devices storing instructions thereon that, when executed by one or more processors, cause the one or more processors to:
receive image data from the camera system;
transmit the image data to an object detection system;
determine, based on stored data, whether the object is expected to be present for collection at a location; and
based on determining that the object is expected to be present for collection at the location, instruct the camera system to store an image of the location on the one or more memory devices.

17. The refuse vehicle of claim 16, wherein the instructions further cause the one or more processors to:
based on an output from the object detection system, determine whether the object is present at the location; and
determine whether the object is collected.

18. The refuse vehicle of claim 16, wherein the one or more processors instruct the camera system to store the image of the location based on determining at least one of:
the object is present at the location, the object is expected to be present for collection at the location, and the object is not collected;
the object is not present at the location, the object is expected to be present for collection at the location, and the object is not collected; and
the object is present at the location and the object is not expected to be present at the location.

19. The refuse vehicle of claim 16, wherein the instructions further cause the one or more processors to store data relating to collection of the object, the data comprising at least in part a determination of whether or not the object is collected.

20. The refuse vehicle of claim 16, wherein the instructions further cause the one or more processors to transmit a notification to a driver of the refuse vehicle.
